(19) United States
(12) Patent Application Publication
(10) Pub. No.: US 2021/0209691 A1
(43) Pub. Date: Jul. 8, 2021

(54) VERIFYING THE USE OF UNMANNED AERIAL VEHICLES

(71) Applicants: Jose Vincente Salazar Ibanez, Carranquilla (CO); Juri Krlin, San Diego, CA (US); Robert Timothy Stuart Latta, San Diego, CA (US)

(72) Inventors: Jose Vincente Salazar Ibanez, Carranquilla (CO); Juri Krlin, San Diego, CA (US); Robert Timothy Stuart Latta, San Diego, CA (US)

(73) Assignee: DOME INSURANCE, INC., San Diego, CA (US)

(21) Appl. No.: 16/075,114

(22) PCT Filed: Feb. 2, 2017
(86) PCT No.: PCT/US2017/016281

§ 371 Date: Aug. 2, 2018

Related U.S. Application Data
(60) Provisional application No. 62/290,397, filed on Feb. 2, 2016.
(60) Provisional application No. 62/375,529, filed on Aug. 16, 2016.

(51) Int. Cl. G06Q 40/08; G06Q 10/10; H04W 4/021; H04W 4/12; B64C 39/02

(52) U.S. Cl. CPC G06Q 40/08; G06Q 10/10; B64C 39/024; H04W 4/12; H04W 4/021

(57) ABSTRACT

Monitoring the use of motorized recreational vehicles and digitally verifying claims related to the use of motorized recreational vehicles including providing insurance for motorized recreational vehicles in response to an indication that the motorized recreational vehicles have entered a region requiring insurance

### CROSS-REFERENCE TO RELATED APPLICATIONS

This application claims the benefit of and priority to PCT Application No. PCT/US2017/016281 filed Feb. 2, 2017 and entitled “Verifying the Use of Insured Vehicles” which claims the benefit of and prior to U.S. Provisional Patent Application No. 62/375,529 filed Aug. 16, 2016 and entitled “Verifying The Use of Motorized Recreational Vehicles,” and U.S. Provisional Patent Application No. 62/290,397 filed on Feb. 2, 2016 and entitled “Providing Insurance Policies for Using Motorized Recreational Vehicles,” the disclosures of which are incorporated herein by reference in their entireties.

### TECHNICAL FIELD

The subject matter described herein relates to monitoring the use of airborne vehicles through geolocation sensors associated with the recreational vehicles and digitally verifying the occurrence of events related to a policyholder's use of the airborne vehicles.

### BACKGROUND

Annual insurance policies that cover liability during the performance of an activity that is performed sporadically can be expensive. The number of people participating in hazardous activities is increasing at an ever-expanding rate and the risk elements that need to be taken into account for insurance policies covering liability arising from these activities mean that traditional insurance providers are unable to effectively and efficiently provide insurance policies for participants in these sporadically performed activities.

### SUMMARY

In one aspect, systems, methods, apparatuses, and the like, are described having and/or capable of performing one or more operations. Obtaining sensor data from a geolocation sensor. The sensor data can include an indication of a location of an unmanned vehicle. A location of the unmanned vehicle can be determined based on the indication of the location provided by the sensor data. One or more condition parameters can be obtained for one or more conditions at the determined location of the unmanned vehicle. An insurance policy premium for an insurance policy covering use of the unmanned vehicle for a set period of time can be determined. The insurance policy premium can be based on the determined location of the unmanned vehicle and the one or more condition parameters. An indication of the insurance policy premium can be transmitted for display on a graphical user interface of a device associated with a user of the unmanned vehicle. The indication of the insurance policy premium can be transmitted over a data connection.

Confirmation data indicating an acceptance of the insurance policy premium can be received from the device over the data connection. The acceptance received from the user through the graphical user interface. A time of acceptance of the insurance policy premium by the user, can be logged. A notification can be provided to the user, through the graphical user interface of the device associated with the user, upon expiration of the set period of time.

Additional sensor data can be received from the geolocation sensor that includes an indication of the location of the unmanned aerial vehicle during the set period of time. The additional sensor data can be received at least periodically during the set period of time, and/or the additional sensor data can be received at the expiration of the set period of time.

The geolocation sensor can be disposed on the device associated with the user, the unmanned aerial vehicle, a controller of the unmanned aerial vehicle, or the like. The device can be a mobile device, such as a smartphone, tablet, laptop, or the like. The device can be a controller of the unmanned aerial vehicle.

The one or more conditions includes a proximity of the location of the unmanned aerial vehicle to one or more of an airport, a school, and a restricted area, a population density at the location of the unmanned aerial vehicle, or the like.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an illustration of a system for verifying the location of unmanned vehicles and ensuring compliance with an insurance policy, having one or more features consistent with the current subject matter;

FIG. 2 is an illustration of a user device having a graphical user interface with one or more elements consistent with the present description;

FIG. 3 illustrates a system for facilitating verification of maintenance of unmanned vehicles, having one or more features consistent with the present description;

FIG. 4 is an illustration of a graphical user interface presented through a user device, such as user device, or the like, having one or more features consistent with the present description;

FIG. 5 is an illustration of a map for use with an application having one or more features consistent with the present description;

FIG. 6 is an illustration of a map for use with an application having one or more features consistent with the present description;

FIG. 7 is an illustration of a graphical user interface for use with an application having one or more features consistent with the present description;

FIG. 8 illustrates a user device having a graphical user interface 802 with one or more elements consistent with the present description;

FIG. 9 illustrates data communication in a system having one or more features consistent with the present description;

FIG. 10 is an illustration of a graphical user interface for use with an application having one or more features consistent with the present description;

FIG. 11 is an illustration of a user device having a graphical user interface with one or more elements consistent with the present description;

FIG. 12 is an illustration of a system having one or more elements consistent with the present description;

FIG. 13 is an illustration of a graphical user interface having one or more elements consistent with the present description;

FIG. 14 is an illustration of a graphical user interface having one or more elements consistent with the present description;

FIG. 15 is an illustration of a system for facilitating obtaining of an insurance policy for a motorized recreational vehicle by a user who is not able and/or willing to contract with an insurance provider, having one or more features consistent with the present description;

FIG. 16 illustrates a method having one or more features consistent with the current subject matter;

FIG. 17 illustrates a method having one or more features consistent with the current subject matter;

FIG. 18 illustrates a method having one or more features consistent with the current subject matter;

FIG. 19 is an illustration of a system having one or more features consistent with the present description;

FIG. 20 illustrates a system having one or more features consistent with the present description;

FIG. 21 illustrates geofencing for unmanned vehicles;

FIG. 22 illustrates a representation of a geographic region; and

FIG. 23 illustrates a mobile device displaying a user interface having one or more features consistent with the present description.

### DETAILED DESCRIPTION

Traditional insurance providers are unable to provide episodic policies for the casual participant in hazardous activities because they have no way of verifying that a loss-incident took place during a period where an insurance policy is active. The present subject matter solves this issue by describing systems, methods and apparatuses for verifying the existence of an episodic policy during a period in which a loss-incident has occurred and confirming the location of the policy holder and/or equipment associated with the policy holder.

Activities contemplated by the present description include using unmanned vehicles, using motorized vehicles, skydiving, paragliding, flying ultra-lite aircraft, kite surfing, surfing, cycling, skating, rollerblading, skiing, snowboarding, or the like. Participating in such hobbies can lead to liabilities as well as the risk of personal injury and damage to property. Currently, the only insurance policies available to sporadic participants in such activities are limited to ones that have relatively long and fixed-length terms. Such a policy may be effective on an annual basis or as part of a fixed-term coverage, such as for a vacation, but for casual participants who desire to participate in a hobby or activity on a regular, but intermittent, basis such policies may be prohibitively expensive.

Insurance policies typically have a fixed start date and a fixed finish date. This allows for certainty in knowing a policy is in place when a loss-incident occurs during the policy period. However, such policies are also expensive on a per-activity basis for the casual participant. For example, an annual insurance policy that covers liabilities arising out of the use of motorized recreational vehicles can exceed the value of the motorized recreational vehicle.

The present subject matter uses technical aspects of mobile computing devices of a user, controllers of an unmanned vehicle of the user, the unmanned vehicle of the user, equipment onboard a recreational vehicle, or the like.

Unmanned vehicles can include, for example, unmanned aerial vehicles, unmanned underwater vehicles, unmanned surface vehicles, unmanned land vehicles, radio-controlled planes, radio-controlled boats, radio-controlled balloons, radio-controlled cars, radio-controlled trucks or the like. Motorized recreational vehicles can include motorized personal transportation devices. Motorized personal transportation devices can include, for example, electric mobility devices, electric skateboards, electric skates, electric scooters, hover boards, Segways, motorized bicycles, motorized unicycles, monowheels, electric tricycles, electric three-wheeled scooters, minibikes, ATVs, motorcycles, or the like.

Typically, these unmanned vehicles are uninsured or underinsured. Insurance underwriters are no longer automatically including losses arising from the use of such motorized recreational vehicles in home or renters liability insurance policies. Annual insurance policies for using such motorized recreational vehicles are expensive and often account for more insurance than is required by the typical user of such motorized recreational vehicles. These annual insurance policies often run more than the cost of the motorized recreational vehicles themselves.

By providing insurance policies that cover liabilities arising from participation in activities only when the participant is actually participating, the cost of insurance can be significantly reduced for those individuals, thereby allowing the sale of insurance policies to individuals who would otherwise forgo with insurance.

One of the biggest risks to an insurance carrier that provide such episodic insurance is the risk of fraud. Unlike insurance policies that run for a specified term, episodic policies can be misused. For example, an insured could be involved in a loss-incident during a period that they did not have an insurance policy in place and later activate an insurance policy and claim the loss occurred during the period of that insurance policy. The present subject matter facilitates the verification that the loss-incident actually occurred during a time when an insurance policy was in place.

Policies may have restrictions on the type of use of unmanned vehicles. For example, a commercial unmanned aerial vehicle may be insured for inspecting infrastructure, but may be restricted from inspecting fish stock, or monitoring weather conditions. Policies may have restrictions on where an unmanned vehicle can be used. For example, the same commercial unmanned aerial vehicle may be insured for operation in around highways infrastructure but not in major downtown areas, or in rural areas. The presently described subject matter can facilitate verification that the operator of the unmanned vehicle is complying with policy limits.

Verifying that an insurance policy was in place at the time of a loss-incident includes monitoring or verifying the use of equipment associated with an insured activity. Furthermore, verifying that a user is complying with the terms of the policy can be accomplished through monitoring the insured's use of equipment, location, and the like. For Example, the use of a motorized recreational vehicle can be monitored or verified to ensure compliance with insurance policies, laws, rules, codes, ordinances, judgments, opinions, or the like, in the jurisdiction(s) that the motorized recreational vehicle is being used.

To facilitate the mitigation of losses to an insurer, the present description describes subject matter for notifying owners and/or users of unmanned vehicles and/or participants in hazardous activities, of high-risk areas, or regions where it is prohibited to use certain motorized recreational vehicles or participate in a certain hazardous activity.

The presently described subject matter applies to individual insurance policies as well as group or commercial insurance policies. For example, an unmanned vehicle can be used by a casual user for recreational purposes or can be used by a professional in the course of their business, for example, a photographer, videographer, surveyor, search and rescue professional, relator, or the like. Consequently, unmanned vehicles can include one or more of motorized recreational vehicles, motorized commercial vehicles, non-motorized recreational vehicles, non-motorized commercial vehicles, or the like. Motorized recreational vehicle can include any vehicle, toy, or article, the use of which could lead to liabilities that would benefit from an insurance policy being in place.

The present description at times refers to specific types of motorized recreational vehicles, unmanned vehicles, or equipment associated with an activity. However, the subject matter and the concepts that it describes can be applied to any type of motorized recreational vehicle or equipment for any type of activity. This description is not intended to be limiting, but is intended to provide exemplary descriptions of the subject matter that can be applied to any motorized recreational vehicle and/or equipment for any type of activity.

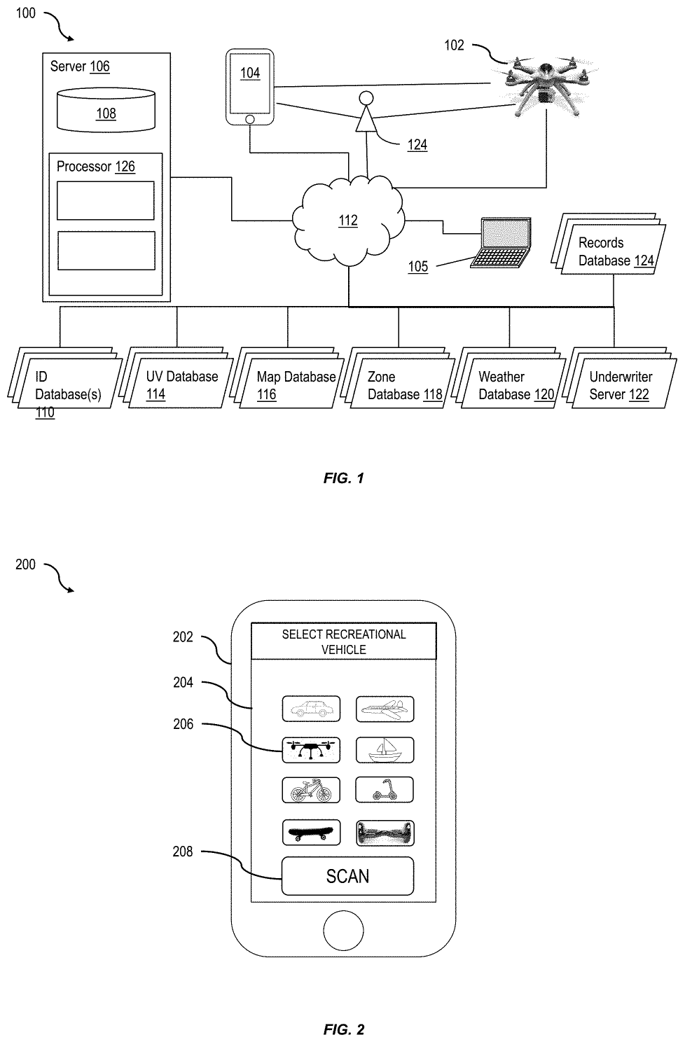

FIG. 1 is an illustration of a system 100 for providing insurance coverage for liabilities arising out of the participation in an activity, having one or more features consistent with the current subject matter. Specific reference is made, with respect to FIG. 1, to the use of motorized recreational vehicles 102, for example an unmanned vehicle. However, features described herein are applicable generally to sporadically performed activities. An application can be provided for execution on a user device 104. A user device 104 can include a smartphone, cellphone, PDA, tablet, laptop, desktop, netbook, smartwatch, wearable, specialized computing device for application on a motorized recreational vehicle, specialized computing device for executing the application, or the like. In some variations, a web interface, fat client application, or the like, can be provided for providing one or more of the features described herein.

The application can be configured to cause the user device 104 to perform one or more actions. The one or more actions can include interacting with a server 106. The server 106 can be configured to support one or more features of the application executed on the user device 104. For example, the server 106 can receive data from the user device 104, perform one or more calculations, generate data, obtain data from third-parties, transmit data to the user device 104, or the like. The application executed on the user device 104 can facilitate providing insurance services to a participant in an insurable activity. An insurable activity is one which may result in liability on the part of the participant in, and/or owner of equipment associated with, the insurable activity. For example, the user device 104 can facilitate providing insurance services to a user and/or owner 124 of the motorized recreational vehicle 102.

The application can be configured to cause the user device 104 to provide a graphical user interface on a display of the user device 104. The graphical user interface can be configured to present information to the user of the user device 104. The graphical user interface can be configured to facilitate selection, by the user of the user device 104, of an insurance policy for the insurable activity. The graphical user interface can be configured to facilitate entry and/or selection, by the user through the user device 104, of one or more options associated with the buying of an insurance policy. For example, the graphical user interface can be configured to facilitate entry and/or selection of one or more insurable activities that the user intendeds to participate in.

Although the present description provides illustrations of the current subject matter being executed on a mobile device, this is not intended to be limiting. The application described herein can be executed on any type of computing device with any type of peripheral input devices for entering and/or selecting options and/or entering information. In some variations, some functions described herein may be performed on one type of computing device, while other functions may be performed on another type of computing device. In some variations, multiple computing devices can work in concert to perform some or all of the functions described herein. The functionality ascribed to the application can be performed using one or more desktop computers. The application can be provided as a native application on a mobile computing device, a web-application on a mobile computing device, through a website accessible by a mobile computing device or desktop computing device, or the like.

The user device 104 can be configured to facilitate registration of a user. Registration of a user with the application can set up an account for the user with the insurance provider. The account can be maintained by server 106. The application can be configured to require a user to provide one or more pieces of identifying information. For example, the user can provide an email address, physical address, telephone number, a license number, certificate information, government-issued identification number (for example a Social Security Number), age, gender, or the like.

In some variations, the application can be configured to facilitate registration through a third-party provider. For example, the application when initiated on the user device 104 can be configured to present a request through the graphical user interface for entry of third-party service log-on information. Third-party providers can include FaceBook, Google, Twitter, or the like. The application can be configured to link with the third-party provider and request permission to obtain information about the user. In response to the sign-in with the third-party provider and approval of the request to obtain information about the user, information about the user can be obtained from the third-party provider and stored. Upon login with the third-party provider the application can be configured to obtain additional information from the user. The user information can be stored on the user device 104, on the server 106 in an account associated with the user, or the like.

In response to receiving the user information, including user identity information, the user information can be verified. The user information can be verified using the user device 104, the server 106, a third-party verifier, or the like. User information that is saved on the user device 104 may be accessed using the application. For example, the application may be configured to cause the user device 104 to provide make, model, serial number, or the like, of the user device 104. This information can be used to verify the user. Other user information may be stored on the user device 104 which can be provided for use by the application.

In some variations, the application can be configured to cause the user device 104 to transmit the user information, collected on the user device 104, to a server 106. In some variations, the user information may have been gathered by the server 106 from one or more third-party sources. The collection of information by the server 106 can be aided by the user device 104.

The server 106 can include electronic storage 108. The electronic storage 108 can include a database of information associated with the identity of one or more individuals. The server 106 can be configured to compare the identity information provided by the user through the user device 104, and/or by a third-party provider, with the database of information in the electronic storage 108. In some variations, the server 106 can be configured to query an identity database 110. The identity database 110 can be provided and maintained by a third-party. In some variations, the identity database 110 can be maintained by the same organization(s) that maintains the server 106. The identity database 110 can be accessed over a network, for example the Internet 112, a dedicated secure network, or the like.

The server 106 can be configured to transmit the user information to the identity database 110. The server 106 can be configured to encrypt the user information prior to transmission. The identity database 110 can be configured to compare the user information with one or more records stored on the identity database 110. In response to verifying that the user information is correct, the identity database 110 can be configured to transmit data to the server 106 confirming the veracity of the user information. Where user information is inconsistent, the identity database 110 can transmit a notification to the server 106 that includes an indication that the identifying information is not verifiable. The notification can include an indication of the inconsistency. The server 106 can facilitate transmission of a notification to the mobile device indicating that the user information is inconsistent and request correction or confirmation of the information from the user. The server 106 and/or the provider of the identity database 110 can be configured to generate a notification to an administrator to perform one or more tasks to verify the user information. The one or more tasks can include a telephone call to the user, a text message, or the like.

The application can be configured to request information about past insurance claims made by the user, past liability claims made by or against the user, any current or prior law suits that the user has been a party to, any and all disputes related to the user, or the like. This information can be verified by one or more third-party services.

The application can be configured to cause the user device 104 to encrypt user information prior to transmitting the user information to the server 106 and one or more third-party services. In some variations, the application can be configured to cause the user device 104 to encrypt sensitive information only prior to transmission. Sensitive information can include information that would identify the user should the information become public. Similarly, the server 106 can be configured to encrypt information prior to transmission of information and decrypt information received.

In some variations, user information may be transmitted from a user device 104 to a server 106 supporting an application initiated on the user device 104. User information may be encrypted by the user device 104 and unencrypted by the server 106, or vice versa. The server 106 may selectively provide information to one or more third-party services during the user verification process. In this manner, only information that a third-party service is permitted to receive may be transmitted by the server 106 to the third-party service. In some variations, the server 106 may be configured to transmit portions of the user information for transmission to one of the third-party services

Although the present description describes the identity database, UV database, map database, one database, weather database and underwriter server as being third-party services and being separate databases and services, this is for illustrated purposes only. The present subject matter contemplates that one or more of the databases or services can be combined by a single provider, or be incorporated into the functionality of the server 106.

FIG. 2 is an illustration 200 of a user device 202 having a graphical user interface 204 with one or more elements consistent with the present description. An application can be initiated on the user device 202 facilitating the generation of the graphical user interface 204. The application can be configured to request entry, through the graphical user interface, of information about a user's insurable activity. For example, the application can request a type of insurable activity. In the example illustrated in FIG. 2, the user has selected that the insurable activity is the use a motorized recreational vehicle. The user can enter and/or select the type of motorized recreational vehicle through one or more buttons 206 presented through the graphical user interface 204. Types of motorized recreational vehicles can include radio controlled vehicles, radio controlled airplanes, unmanned aerial vehicles, unmanned land vehicles, unmanned water-going vehicles, motorized bicycles, motorized scooters, motorized skateboards, motorized hoverboards, Segways, or the like.

The present description contemplates providing insurance policies and verifying participation in different insurable activities. For example, skydiving, paragliding, flying ultra lite aircraft, flying aircraft, skiing, snowboarding, water skiing, off-roading, skating, mountain biking, racing, horse riding, motorcycling, cycling, any extreme or hazardous sport, or the like.

The application can be configured to request, through the graphical user interface, attributes of the equipment being used to participate in the insurable activity. For example, the application can be configured to request, through the graphical user interface, attributes of a motorized recreational vehicle that a user intends to use during their insured period. Attributes of equipment can include make, model, dimensions, performance characteristics, value, weight, or the like. Attributes of motorized recreational vehicles, for example, can include the make, model, serial number, color, alterations, performance enhancements, payload or the like, of the motorized recreational vehicle. In some variations, the graphical user interface can include drop-down menus to select the attributes of the equipment. The user can be prompted to select, from the drop-down menu, or the like, the attributes of the equipment. Where attributes are not provided in the drop-down menu, or the like, the user can be invited to input the attribute information.

Some equipment may have a unique identification number. For example, motor vehicles include a unique vehicle identification number or VIN. In some variations, the application can request a unique identification number of the equipment, for example, a serial number, a government registration number, or the like. The application can be configured to cause the user device 104 to query a database that contains information about equipment associated with a unique identification number. For example, a motorized recreational vehicle database 114 can include information about motorized recreational vehicles associated with unique identification numbers of motorized recreational vehicles. The motorized recreational vehicle database 114 can comprise a plurality of databases. Databases can be maintained by vehicle manufacturers, third-parties, government entities, insurance providers, or the like.

Information contained in databases associated with equipment, for example, the records of the motorized recreational vehicles, can be used to populate, in the graphical user interface, the unknown information about the equipment being entered by the user. In some variations, entries can be automatically selected when the user enters certain information. For example, where the user provides a unique identification number for the motorized recreational vehicle, attributes about that particular motorized recreational vehicle can be populated automatically based on a query with the motorized recreational vehicle database 114. In other variations, in response to providing a make and model of the motorized recreational vehicle, attributes such as color, year of manufacture, or the like, can be automatically populated, in the graphical user interface.

The records contained in databases associated with equipment can also be used to verify the information entered by the users. For example, information about the attributes of the motorized recreational vehicle, provided by the user, can be verified for veracity. For example, attributes such as make, model, serial number and color should be verifiable and should match with record(s) of the motorized recreational vehicle database 114. Where the attributes entered by the user do not match with the recreational vehicle database 114, a notification can be presented to the user asking for correction of the information provided and/or different information. A notification can be transmitted to an administrator for follow-up with the user. Such follow-ups can include a phone call, text message, email, or the like. In certain variations if the attributes, entered by the user, cannot be verified the user may be prompted to certify that the entered information is correct.

Information obtained from a database associated with equipment that a user intends to use in their pursuit of an insurable activity can be used to determine various attributes of the equipment. For example, information about the motorized recreational vehicle can include the age of the motorized recreational vehicle, the mode of power, the number of hours used, the maintenance history of the motorized recreational vehicle, the maximum payload of the motorized recreational vehicle, maximum environment conditions (for example, for unmanned aerial vehicles, the maximum wind speed, the maximum temperatures, the minimum temperature, or the like, that the unmanned aerial vehicle can be flown in), the gross weight of the motorized recreational vehicle, features of the motorized recreational vehicle (for example, whether it has geolocation capabilities, safety features, collision avoidance features, or the like), the top speed of the motorized recreational vehicle, a replacement cost for the motorized recreational vehicle, repair costs for the motorized recreational vehicle, a terminal velocity of the motorized recreational vehicle, or the like.

In some variations, equipment will need to be maintained. Proof of maintenance of equipment may need to be obtained prior to allowing the issuance of an insurance policy for participating in an activity that uses that equipment. Maintenance may need to be performed by a certified maintenance professional. For example, policies or regulatory requirements may require that all unmanned aerial vehicles, say, complete periodic maintenance inspections to verify that the unmanned aerial vehicles are air worthy.

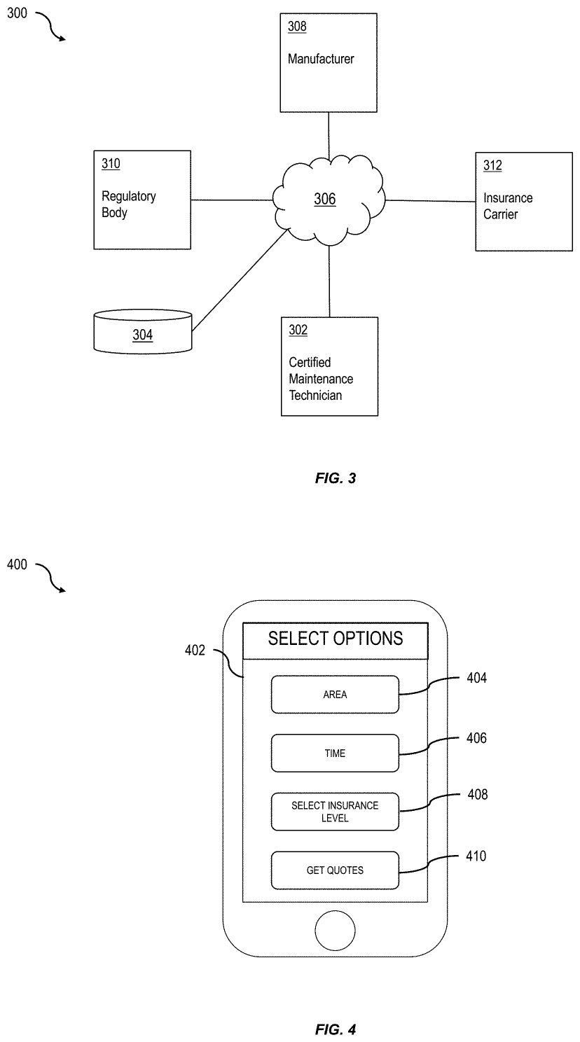

In some variations, certified maintenance technicians may report the condition of the unmanned recreational vehicles to a central regulatory agency. FIG. 3 illustrates a system 300 for facilitating verification of maintenance of equipment, such as unmanned recreational vehicles, having one or more features consistent with the present description. In some variations, a certified maintenance technician 302 may perform maintenance and verify the condition of equipment, such as an unmanned recreational vehicle. The equipment may have a unique identification number which can identify the equipment and the type of maintenance it requires. The certified maintenance technician 302 may be provided with a maintenance platform through which the certified maintenance technician 302 can certify that they have performed the necessary inspections and maintenance on the equipment having the unique identification number.

The maintenance information provided by the certified maintenance technician 302 can be stored and maintained on a database 304. The information provided by the certified maintenance technician 302 may be transmitted through a network 306, such as the Internet.

The unique identification number of the unmanned recreational vehicle may be provided by the manufacturer 308.

One or more regulatory bodies 310 may be charged with facilitating registration of equipment, such as unmanned recreational vehicles. For example the FAA maintains a registration database of unmanned aerial vehicles. The database 304 may be maintained by the regulatory body 310. Periodic registration renewals may be required by the regulatory body 310. Prior to allowing registration or renewal of the registration, the regulatory body 310 may consult with the database 304 to verify that the equipment has been maintained and/or serviced by a certified maintenance technician 302.

One or more insurance carriers/providers 312 may require compliance with regulations laid down and/or overseen by the regulatory body 310. Then a user requests an insurance policy the insurance provider(s) 310 may consult with the database 304 to verify that the user's equipment complies with all regulations.

The application can be configured to request qualification information of the user. Qualification information of the user can include certifications, professional training, hours of use, type of use, or the like, with respect to the equipment, such as motorized recreational vehicle 102. For example, when the motorized recreational vehicle is an unmanned aerial vehicle, qualifications can include a pilot's license, unmanned aerial vehicle license, hours of flight-time, night qualifications and/or experience, instrumental flight qualifications and/or experience, or the like.

The user's qualifications can be verified. The user device 104 and/or server 106 can be configured to transmit the user's qualification information to a third party service maintaining information about qualifications with respect to types of equipment. For example, where a user provides a qualification and a certification or license number for a motorized recreational vehicle, a database containing this information, for example records database 124, can be queried to verify the user's qualifications.

The application can be configured to facilitate purchase of insurance for the participation in an insurable activity. For example, when the activity is using a motorized recreational vehicle 102, the application can be configured to facilitate purchase of an insurance policy for using the motorized recreational vehicle 102. The application can be configured to facilitate the purchase of any type of insurance for a motorized recreational vehicle 102. For example, the user can purchase hull insurance. Hull insurance can cover the cost of damage to the motorized recreational vehicle itself based on collision damage, or the like. The user can purchase liability insurance for covering the cost to, and claims by, third-parties caused by the motorized recreational vehicle and/or the user's operation thereof.

The application can be configured to facilitate the purchase of long-term insurance, such as annual, or semi-annual insurance.

The application can be configured to facilitate the purchase of short-term insurance. For example, the application can be configured to facilitate the purchase of insurance for an instance of participation in an insurable activity. A user may intend to use of a motorized recreational vehicle for a short period of time. An insurance policy can be purchased immediately prior to the use of the motorized recreational vehicle and the user can be charged on a periodic basis, for example, on a per minute basis, for the period of time that the user is using the motorized recreational vehicle. An insurance policy can be purchased at some time prior to the use of the motorized recreational vehicle. In such situations, a user can be provided a deadline, for example, of when to commence their use of the motorized recreational vehicle in a designated location. Such uses can include the purchase of insurance to cover the use of the motorized recreational vehicle during a scheduled event. An event can include a private event, public event, sports event, or the like. Prior to the use of the motorized recreational vehicle at an event, a user can purchase an insurance policy for that event. Where the event is a public event or sports event, characteristics of the event may be obtained and/or verified from third-party providers. For example, where the event is a sports event, the system can be configured to obtain information about the sports event, including the event type, the venue, the predicted number of spectators, the number of participants in the sports event, where the participants will be located with respect to the motorized recreational vehicle, or the like.

FIG. 4 is an illustration 400 of a graphical user interface 402 presented through a user device, such as user device 104, 105 or the like, having one or more features consistent with the present description. The graphical user interface 402 presented in FIG. 4 is for illustrative purposes only, other designs and layouts are contemplated by the present subject matter. FIG. 4 illustrates a graphical user interface 402 having one or more specific features. This is not intended to be limiting.

The graphical user interface 402 can include one or more buttons. The one or more buttons can facilitate entry and/or selection of information by the user. Buttons can include buttons for selecting an area in which the user intends to participate in an insurable activity, such as using a motorized recreational vehicle 404, selecting a time to participate in the insurable activity 406, selecting an insurance level 408 (including different insurance options), and a button 410 to request insurance policy quotes based on the information provided and/or obtained. In one use example, an area can include a flight area in which a user intends to fly an unmanned aerial vehicle and a use time can include a date and time when the user intends to fly the unmanned aerial vehicle.

The graphical user interface 402 can facilitate selection of an operational area of the equipment associated with participation in the insurable activity through an interaction with a button 404. Different geographical locations will have different levels of risk associated with them. Furthermore, a single geographical location will have different levels of risk for different types of equipment, such as different types of motorized recreational vehicles. Sparsely populated areas may have a low level of risk with respect to liabilities to third parties. For example, if an unmanned aerial vehicle, for example, falls from the sky in a sparsely populated area the chances of hitting a person are relatively low, compared to densely populated areas. Certain geographical locations may have a higher risk of hull damage to a motorized recreational vehicle. Some sparsely populated terrains may have a higher chance of losing the motorized recreational vehicle causing a total loss for the motorized recreational vehicle.

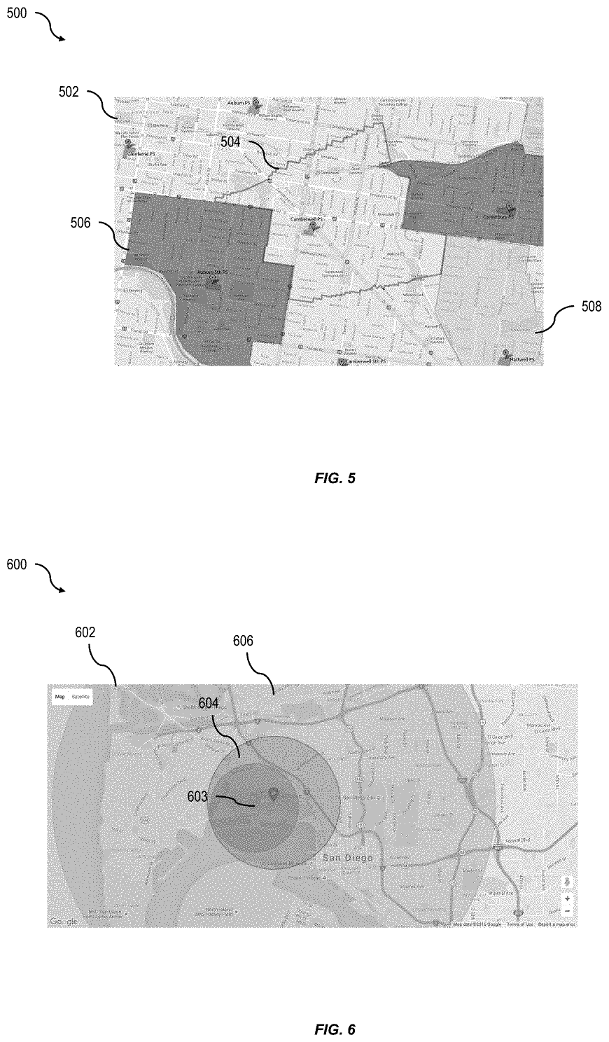

FIG. 5 is an illustration 500 of a map 502 for use with an application having one or more features consistent with the present description. The map 502 can be presented to a user on a display of a user device, such as a user device 104, personal computer 105, or the like. The map 502 can be presented to a user, for example, in response to the user selecting button 504 for selecting the use area. The map 502 can include one or more areas. The areas can be coded. Such coding can include color-coding, shading, display of boundary lines, or the like. The different areas can be coded according to risk or insurance cost. For example, the map 502 can include a low-risk, or low cost, area 504. The low-risk area 504 can be an area of relatively lower risk, and/or relatively lower insurance cost, compared to other areas, such as area 506. Area 506 can be a high-risk area compared to area 504. Area 508 may have a risk that is between the low-risk area 504 and the high-risk area 506. The level of risk of the different areas can be dictated by population density, property values, the likely litigious outcome of a suit, local laws, traffic patterns, the number of other motorized recreational vehicles being operated in an area, the type of motorized recreational vehicle being operated in an area, the number of motorized recreational vehicles in an area being insured by particular underwriters, the surface type in a particular area (e.g. water, open area land, built-up area, quarry), or the like.

The user may select, using the map 502, the area in which the user desires to participate in an insurable activity. Such an insurable activity may include operating a motorized recreational vehicle, such as unmanned aerial vehicle. In response to an interaction, by the user via the graphical user interface, with an area of the map, a notification can be provided to the user of an insurance cost to participate in the insurable activity in that area. The user can either accept or cancel their selection. The user can use an input device of the user device to interact with a particular area. For example, the user can touch, using a touch screen, the screen at a particular area to be presented with additional information about that area. Where the user is using a user device with a mouse, the use can hover over an area, or click on an area, to be presented with the additional information.

The application can be configured to facilitate selection of user-defined areas. User-defined areas can include selecting landmarks between which the user intends to participate in an insurable activity. User-defined areas can include an area drawn on the map by the user. The user may drag their finger, or a mouse pointer, around the periphery of the area in which they wish to participate in an insurable activity.

The application can be configured to facilitate generation of a risk profile for the user-defined area. The risk profile for the user-defined area can be an amalgamation of the various risk profiles of areas within the user-defined area.

The map displayed to the user in response to the user interacting with the area button 404 may include an area in which the user's user device is located. The user's user device may include geolocation technology configured to facilitate the determination of the geographic location of the user device. The map displayed can be a map of the area around where the user device is located.

FIG. 6 is an illustration 600 of a map 602 for use with an application having one or more features consistent with the present description. The map 602 can be presented to a user on a display of a user device in a graphical user interface. The elements of map 602 can be incorporated with map 502 and presented to the user through a display device of a user device. The map 602 can illustrate zones. The zones can be defined based on one or more traits. The traits can include one or more regulations with respect to the participation in an insurable activity. For example, the traits can include one or more regulations with respect to operation of a motorized recreational vehicle, geolocation conditions, or the like. The example, in map 602, specifically illustrates flight regulations around an airport 603. A geographical area may have restrictions on the use of unmanned aerial vehicles. Area 604 indicates an absolute bar to flying unmanned aerial vehicles. Area 604 may be coded, such as color-coded, shaded, have boundary lines, or the like, to indicate that there is an absolute bar to using a motorized recreational vehicle in that area. The application can be configured to bar the user from selecting an area where the use of motorized recreational vehicles is banned. For example, when the user is buying insurance for the use of an unmanned aerial vehicle, the user may be barred from selecting area 604, which is a no-fly zone to all aircraft except for those using the airport 603. The application can be configured to cause a notification to be presented to the user on a display of a user device to indicate that they are not legally permitted to use motorized recreational vehicles in the area they have selected and that if they do so they will not be insured.

Some areas, such as area 606, can include one or more restrictions on the use of motorized recreational vehicles, but otherwise allow the use of motorized recreational vehicles. For example, area 606 can include a height restriction where flying an unmanned aerial vehicle over a particular altitude(s) is prohibited. Upon selection of an area within area 606, the user can be notified of the restriction. The application can be configured to request affirmative confirmation from the user that the user has understood the restrictions and agrees to abide by them. The notification can inform the user that should the user violate the restrictions, the insurance policy would not cover the user.

In some variations, a user need not select an area to participate in an insurable activity. The application can be configured to determine the area from one or more location sensors on the user device and/or the equipment associated with the insurable activity, such as sensors mounted to a motorized recreational vehicle. Based on prior information provided to an insurance provider, the insurance provider can generate an insurance quote and/or provide insurance services to the user automatically in response to an activation, by the user, of the application and/or the equipment. In some variations, the user may specify a location in which insurance is not required or desired. The location may be an area. The area may be geofenced. For example, when the user takes the motorized recreational vehicle outside of that location, the application can be configured to cause the user device to generate a notification asking the user whether they want to purchase insurance for the use of the motorized recreational vehicle. In some variations, the user may specify one or more preferences. One such preference may include that the motorized recreational vehicle is automatically insured once the motorized recreational vehicle leaves, or is used, outside of a specified location.

In response to a selection to participate in an insurable activity in a particular area, and, optionally, to use a particular piece of equipment in the pursuit of the insurable activity, the user can be returned to graphical user interface 402. A user may enter time of use information by selecting button 406. The application can be configured to facilitate a user specifying a start date and time for their insurable activity. The user may specify an end time, specify a duration, or the like. In some variations, the user may specify that they intend to participate in an insurable activity immediately.

In some variations, a quote can be generated that has an expiration date and/or time. The expiration date and/or time can be provided to the user when generating the quote. The user may have to start and/or finish their insurable activity prior to that specified date and/or time in order to receive insurance at the quoted amount.

In some variations, the user may be required to sign-up for a base policy. The base policy can have a fixed term, such as a six-month term, 12-month term or the like. This base policy may have negligible cost, or may have a basic cost rate covering basic elements of the insurable activity. A user may be able to select what constitutes a basic element of the insurable activity and the basic cost rate of the insurance can reflect the definition of the basic elements of the insurable activity provided by the user. When the user exceeds the basic elements of the insurable activity, the user may be charged more for insurance during the time that they exceed the limits of their basic rate insurance policy. For example, the basic rate policy may facilitate use of a motorized recreational vehicle in a low-risk area. When a user uses their recreational motorized vehicle in an area that has a greater level of risk than a low-risk area, the user may be charged more to cover the increased risk.

The user may specify one or more characteristics for their insurance policy. The characteristics of an insurance policy can include the amount of liability coverage, the amount of medical coverage, the amount of property coverage, hull coverage, or the like. The user may specify an amount of liability coverage they desire to have. In some variations, different areas may have different laws requiring certain minimum amounts of liability coverage. The application can be configured to indicate this and not permit purchase of insurance below having liability coverage below the legal minimum amount. The user may specify whether they want hull insurance to insure against damage to equipment, such as motorized recreational vehicles. The user may specify whether they want payload insurance to insure against damage to the payload carried by the equipment, for example, to cameras or communication equipment carried by the equipment. The user may specify the amount of deductible they wish to include in the insurance policy.

After inputting the insurance characteristic information the user may be presented with one or more quotes for providing insurance to cover their participation in the insurable activity. In response to receiving the insurance characteristic information, the application can cause the user device 104, personal computer 105, or the like, to transmit the information to a server 106. The server 106 can be configured to determine an insurance premium(s) for the user's participation in the insurable activity based at least on the information provided by the user, information obtained from a user device associated with the user, the equipment used when participating in an insurable activity, a controller of the equipment, one or more third-party information providers, or the like.

The insurance premium(s) can be based on a number of additional factors, including a number of different risk factors. Risk factors can include the area in which the use of the unmanned vehicle is to take place. Information about the area can be obtained, by the server 106, from a map database 116. The map database 116 can include population density information, surface information, property information, traffic information, or the like. Information about different zones, such as no-use zones, regulations in zones, or the like, can be obtained from a zone database, such as zone database 118. Weather at the desired use location at a particular time and day can affect the risk factors when calculating insurance premiums. The server 106 can be configured to query one or more weather databases, such as weather database 120, to obtain weather information. Risk factors can include the time of day and visibility conditions in which the insurable activity will be conducted. This information can be stored on the server 106 or obtained from third-party information providers.

In some variations, the application can be configured to cause the user device 104 to communicate directly, albeit through webservers and the like, with third-party services and databases. In some variations, the application can be configured to cause the user device 104 to communicate with third-party services through the server 106.

Risk factors accounted for can include a user's qualifications and experience in operating the unmanned vehicle. Risk factors can include the make and model of the equipment, such as the make and model of the motorized recreational vehicle. For example, some makes and models of equipment may be better equipped to deal with unexpected weather conditions than others. Some makes and models of equipment may be cheaper than others, or easier to repair than others. The lighter a equipment is, the less likely it is to cause damage to others, thereby reducing the liability risk.

Risk factors described herein are not intended to be limiting, but are illustrative of the kinds of the risk factors that can be used in computing a level of risk for facilitating determination of an appropriate insurance premium. Any information provided by the user, or obtained about the user, the equipment used by the user, the geographic location, time of day, or the like, can be used to facilitate computing of a level of risk.

The insurance premium can also depend on a level of medical coverage for the policyholder, operator, or passengers of the equipment.

The insurance premium can be based on maximum levels of coverage selected by the policyholder.

The insurance premium can also depend on a risk determination by insurance underwriters. Individual underwriters can assess risk at different levels. The server 106 can query insurance underwriters to determine insurance costs for a particular use of a motorized recreational vehicle. The server 106 can obtain underwriter information from one or more underwriter servers 122. The underwriter information for a particular insurance underwriter can be used to determine an insurance premium(s) for obtaining insurance through that particular underwriter for the desired insurable activity.

The server 106 can be configured to access actuarial tables to determine risk factors. The actuarial tables can be stored in electronic memory 108, or can be obtained from one or more external sources. The server 106 can be configured to facilitate updating of the actuarial risk tables in real-time as they receive information from users, databases, receive claims pay on claims, or the like.

After determining the insurance premium(s), the insurance premium quotes can be presented to the user. The user can select one of the insurance quotes and pay the required insurance premium prior to commencing their participation in the insurable activity.

Purchase can be accomplished through one or more payment systems. The insurance can be purchased through payment with a credit card, debit card, prepaid card, bank transfer, or the like. The insurance can be purchased using an electronic payment services, for example, google wallet, paypal, or the like. In some variations, an account can be preloaded with an amount of money and the insurance premium can be deducted from the account balance.

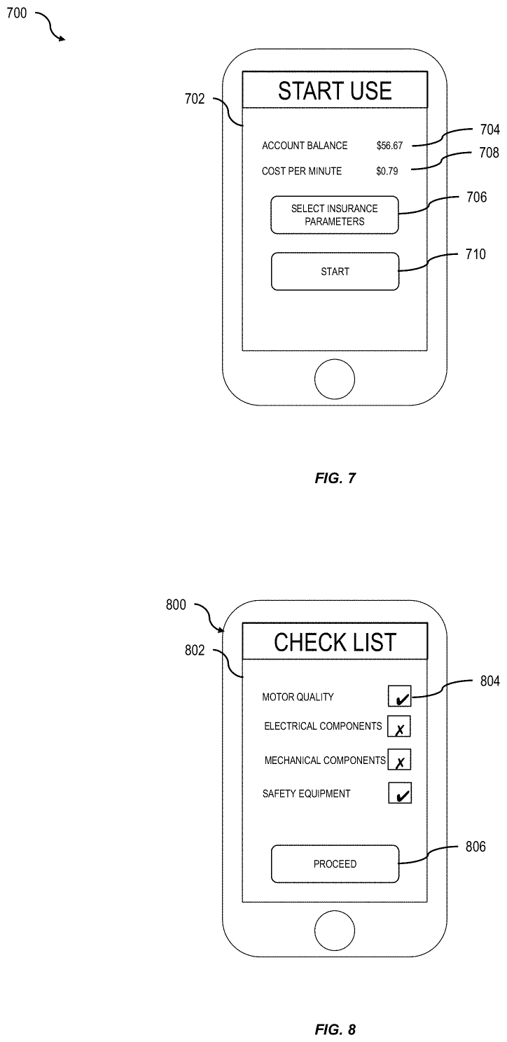

FIG. 7 is an illustration 700 of a graphical user interface 702 for use with an application having one or more features consistent with the present description. In some variations, a user can prepay into an account associated with an insurance provider. The insurance provider can be configured to facilitate the purchase insurance from a plurality of different underwriters or other insurance providers using the money from the user's account. The graphical user interface 702 can be configured to present an account balance 704 to the user.

The user can select one or more insurance characteristics through interaction with a button, such as button 706. The insurance characteristics can include an amount of liability coverage, hull protection, payload protection, deducible, medical coverage, or the like. The insurance characteristics can include location information for the insurable activity.

An insurance cost 708 can be generated in response to input of the insurance characteristics, location information, user information, and other parameters. The insurance cost 708 can be determined in a similar manner as discussed with respect to FIG. 4. The insurance cost 708 can be unit-based. Such units can include time, distance, or the like. For example, the insurance cost 708 can be presented as a cost-per-minute, a cost-per-mile, or the like, insurance cost. In some variations, the insurance cost can be provided as a combination of different unit types.

When the user wishes to commence their insurable activity, such as using a motorized recreational vehicle, the user may select the start button 710. This can start a measurement system for measuring time or distance with respect to the user's participation in an insurable activity.

In some variations, the commencement of the insurance policy can occur in response to an indication, received at the mobile computing device and/or an insurance server, that equipment associated with the user and that is used by the user for participating in the insurable activity has started to be used by the user in the designated location. For example, in response to an indication that a motorized recreational vehicle is being used at a location requiring insurance, or at a location that the user has indicated a desire to be insured, the application can be configured to cause the insurance policy timer to commence, ensuring that the user of the motorized recreational vehicle is insured.

In implementations where the user has a deadline by which to participate in the insurable activity, the insurance premium can be automatically billed in response to the passing of that deadline. In some variations, the user may cancel the insurance policy at some time prior to the deadline.

FIG. 8 illustrates a user device 800 having a graphical user interface 802 with one or more elements consistent with the present description. In some variations, prior to a user starting the insurance policy, verification that any equipment required for participation, by the user in the insurable activity, is in a serviceable condition may be made. For example a determination can be made, prior to the commencement of an insurance policy covering the use of motorized recreational vehicles, that the motorized recreational vehicles are in serviceable condition. The verification that the equipment is in serviceable condition may be determined through a pre-use checklist. One example of a pre-use checklist can include a pre-flight checklist of an unmanned aerial vehicle, or drone, prior to commencement of a flight by the unmanned aerial vehicle. A pre-use checklist can include one or more pre-use checklist parameters 804 that must be satisfied prior to use of the unmanned recreational vehicle. Such pre-use checklist parameters 804 can include, for example, a determination of whether one or more motors of the unmanned recreational vehicle are in good condition, whether electrical components of the unmanned recreational vehicle are in good condition, whether mechanical components of the unmanned recreational vehicle are in good condition, and/or the like. The pre-use checklist can include a verification that the safety equipment of the unmanned recreational vehicle is in good condition. For example, for unmanned aerial vehicles, safety equipment can include one or more of collision avoidance and/or detection technology, return-to-base technology in the event of low power or an issue with the unmanned aerial vehicle, or the like. For motorized skateboards, safety technology can include, for example, collision avoidance systems, emergency motor shut-off technology, collision detection technologies, or the like.

The graphical user interface 802 may include one or more radio buttons configured to allow the user to proceed with obtaining or starting the insurance policy in response to the pre-use checklist being satisfied. For example, prior to the pre-use checklist being satisfied the radio button 806 may be greyed out and/or inoperable, denying the user to proceed with obtaining or starting an insurance policy for their participation in the insurable activity.

The pre-use checklist can facilitate ensuring that the equipment that is about to be used in the insurable activity, and therefore insured by the insurance provider, is in serviceable condition, thereby reducing the likelihood that the equipment will cause harm to others based on a defect with the equipment.

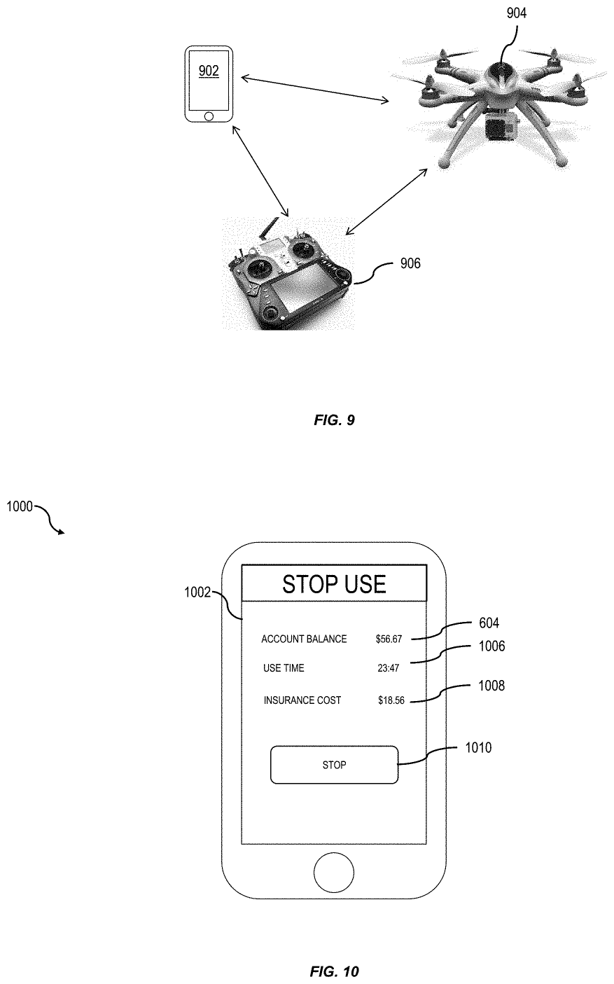

FIG. 9 illustrates data communication in a system having one or more features consistent with the present description. In some variations, parameters associated with the pre-use checklist can be verified by manual entry by a user through the graphical user interface of the user computing device 902. In some variations, parameters associated with the pre-use checklist can be obtained directly from the equipment 904 used by the user in the pursuit of an insurable activity, at the user computing device 902 and through one or more communication channels. Information can be communicated to and/or between the equipment 904 and the user computing device 902 via direct wireless and/or wired electronic communication protocols, or through one or more intermediary devises, such as a controller 906 for the equipment 904, a base station or the like. Parameter information associated with the checklist can, for example, be obtained form a controller 906 of the equipment.

FIG. 10 is an illustration 1000 of a graphical user interface 1002 for use with an application having one or more features consistent with the present description. The graphical user interface 1002 can be presented to the user in response to the user starting the insurance policy by pressing button 710. Graphical user interface 1002 can include a participation counter 1006 indicating the current participation amount in the insurable activity. The participation counter 1006 can, for example, indicate a length of time a user has been operating a motorized recreational vehicle. Graphical user interface 1002 can include an insurance cost 1008 for the participation in the insurable activity. The insurance cost 1008 can indicate a total insurance cost for the current duration of the user's participation in the insurable activity, a current unit-cost, such as cost per minute, for the insurance covering the user's participation in the insurable activity, an average per unit cost, such as an average per minute cost, for insurance covering the user's participation in the insurable activity, or the like. When the user finishes participation in the insurable activity, the user can select button 1010 to stop the insurance policy. In some variations, where the user has an account balance with the insurance provider, in response to the user stopping the insurance police 1010, the total insurance cost 1008 can be deducted from the account balance 704.

In some variations, a user may be billed after they finish their participation in the insurable activity. For example, at the end of the month, the user may be billed for the insurance fees they incurred during that month.

Monitoring a user's participation in an insurable activity can be important for offering liability coverage. Monitoring a user's participation in the insurable activity can facilitate verification that a user has an active insurance policy, for participation in the insurable activity, when a loss-causing event occurs. For example, monitoring the use of the motorized recreational vehicles can facilitate the determination that the motorized recreational vehicle was covered by an insurance policy at the time the motorized recreational vehicle had a collision or some other loss-causing event. Verification that a motorized recreational vehicle, for example, is within a declared location, and/or is being operated in a manner that conforms to an insurance policy or laws may be a requirement imposed by an insurance company in order to honor a claim.

When a user selects a location for participating in an insurable activity, it may be necessary to verify that the user is at that location, or that equipment associated with the insurable activity is present at that location. For example, the location of a motorized recreational vehicle can be verified to ensure that it is being used in the location that the user says it is being used in.

In some use cases an insurance provider may require proof that the user was participating in the insurable activity at the location they say at the time they say they are participating in the insurable activity.

It is typically for participants in hazardous activities to have mobile computing devices with them. These mobile computing device typically have geolocation technology for determining their geographic location. The geolocation technology can include a geolocation sensor, configured to receive geolocation signals for facilitating the determination of the mobile computing device relative to some fixed point. The geolocation technology can include wireless receivers configured to receive signals from one or more geolocation satellites. The geolocation technology can include wireless receivers configured to receive signals from one or more wireless base stations. The signals from the wireless base stations can include an indication of the identity of the wireless base station. The signal strength can provide an indication of the distance between the wireless base station and the mobile computing device. Additional signals from other wireless base stations can facilitate triangulating between the various wireless base stations to determine the position of the mobile computing device.

As previously stated, the make, model, serial number, or the like, of the equipment associated with the user's participation in the insurable activity can be provided by the user when setting up the insurance policy. This information can be used when querying an equipment database 114 to facilitate a determination of the capabilities and features of the equipment. These capabilities can be used to provide an analysis of whether the equipment is capable of exceeding the constraints imposed on the use of the equipment by the insurance policy. For example, when the equipment is a motorized recreational vehicle, it may have a legally limited range, having to stay within line-of-sight of the operator, a set distance from the controller of the motorized recreational vehicle, or the like, an assumption can be made that if the mobile computing device of the user is within a particular area, so is the motorized recreational vehicle. In some variations, the equipment may communicate regularly with the user's mobile computing device. The communication may be over a relatively short-range communication technology. Intermittent or continuous communication between the equipment and the user's mobile computing device can verify that the equipment is within a set range of the user's mobile computing device. Furthermore, the communication itself between the equipment and the user's mobile computing device, may be configured to facilitate determination of the location of the equipment with respect to the user's mobile computing device, and as such, the location of the equipment can be verified.

In some variations, the equipment, such as motorized recreational vehicle 102, can be configured to communicate with a base station, such as base station 124. The base station 124 may have a known location. The signal strength and/or time delay between round-trip transmissions can be configured to facilitate a determination of the location of the motorized recreational vehicle 102 with respect to the base station 124.

When the user activates an insurance policy, such as described with respect to FIG. 4, or FIGS. 6 and 7, the location of the mobile computing device can be verified using one or more of the geolocation sensors. In response to determining that the mobile device is at the location specified by the user, or within a range of the location specified by the user, the mobile computing device can be configured to transmit confirmation of the location of the mobile computing device to an insurance provider server, such as insurance provider server 106. A notification can be provided to the user on the mobile computing device that the location of the mobile computing device has been verified.

In the event that the location of mobile computing device of the user does not match the location specified by the user, a notification can be presented to the user informing them that the mobile computing device is not at the specified location. The notification can include an invitation to correct the specified location. The notification can include a notification that the insurance policy has not been executed due to the disparity in the location specified by the user and the location of the mobile computing device.

The location of the mobile computing device can be monitored continuously or intermittently. In response to the location of the mobile computing device being determined to be outside of a particular insurance zone, or within a no-use zone, a notification can be sent to the user via the mobile computing device, that the insurance policy is no longer in effect. When a mobile computing device is approaching a different insurance zone, or a no-use zone, a notification can be presented to the user to inform them that they are approaching a different insurance zone, or a no-use zone.

Verification that the user's mobile computing device is at the same location as the equipment, used in the user's participation of an insurable activity, may be required. For example, if a claim is made, verification that the user's equipment was at the location specified by the user may be a requirement prior to an insurance provider paying out on the claim. Verification can be performed prior to the commencement of use of the equipment. In some variations, the verification information can be stored by the mobile computing device and/or transmitted to a server, such as insurance server 106, in the event a claim is made. In some variations, verification that the mobile computing device and the equipment were co-located may be a requirement before a claim is honored.

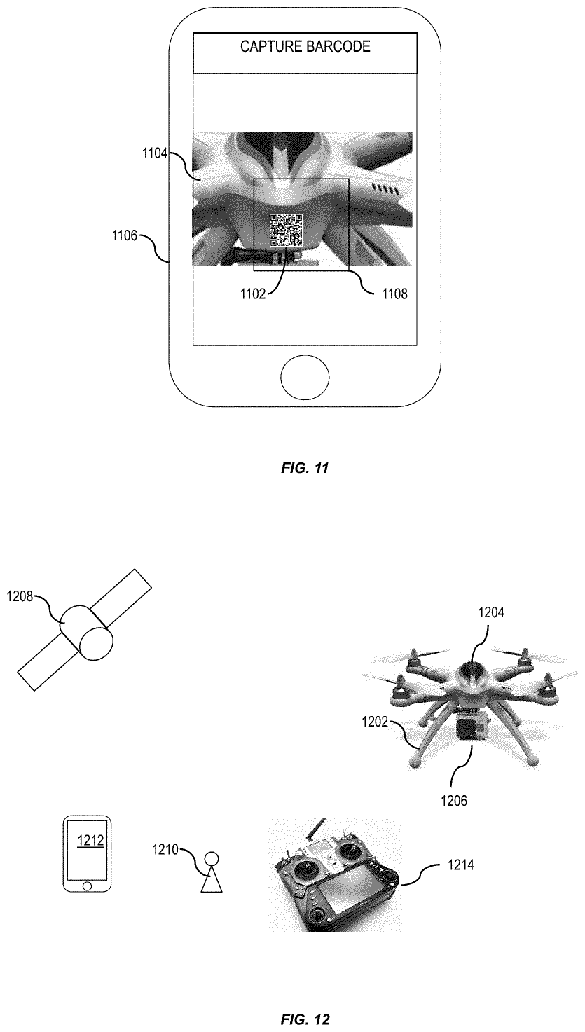

FIG. 11 is an illustration of a user device having a graphical user interface with one or more elements consistent with the present description. Verification that the mobile computing device and the equipment, such as a motorized recreational vehicle, are in the vicinity of each other can be facilitated by a barcode 1102 attached to the equipment, such as the motorized recreational vehicle 1104. The barcode 1102 can be one-dimensional, two-dimensional, three-dimensional, or the like. One-dimensional bar codes can include linear barcodes, or the like. Two-dimensional barcodes can include QR codes, or the like. Three-dimensional barcodes can include different layers or different colors in addition to the two-dimensional barcodes.

A barcode 1102 can be provided to the user after registration by the user. The barcode 1102 can be sent digitally to the user for printing by the user. The barcode 1102 can be sent as a hardcopy, such as through the mail to the user after registration by the user. In some variations, the barcode 1102 can be pre-installed on the motorized recreational vehicle by a manufacturer or distributer. The barcode can be embedded into an outer surface of the hull of the motorized recreational vehicle.

It may be a requirement to register equipment with an governmental organization. For example, unmanned aerial vehicles, boats, ATVs, airplanes, or the like, must be registered and receive a unique registration number. The barcode and the registration number can be integrated. For example, when a user registers for an insurance policy that includes equipment for use in an insurable activity, a barcode can be generated that also includes the governmental registration number of that equipment.

A barcode 1102 can be attached to the equipment, such as a motorized recreational vehicle 1104. An application configured to facilitate verification that the mobile computing device 1106 and the equipment are in the same location can be executed on the mobile computing device 1106. The application can be configured to cause the mobile computing device to request capture of a photograph of the equipment with the barcode 1102 attached to it. The application can be configured to activate an image capturing device of the mobile computing device 1106, for example, a camera, or the like. A video feed captured by the image capturing device can be played on a display of the mobile computing device. The user may interact with the mobile computing device 1106 to capture an image of the equipment with the barcode 1102 attached to it.

The barcode 1102 can include an indication of identifying information encoded within the barcode. In some variations, the barcode 1102 can include an index key, or the like. An index key can be a numeric identifier, an alphanumeric identifier, or the like. The index key can be married to an index key of a row in a database(s) maintained by an insurance provider, a motorized recreational vehicle manufacturer and/or distributor, a third party, a government, or the like. The index key can be a unique identifier assigned to the equipment. The database can include information associated with the equipment, the owner of the equipment, the operator of the equipment, or the like. The database can include a government registration number for the equipment associated with the index key.

In some variations, the barcode 1102 can be configured to include encoded information without the need to reference a database. For example, the barcode 1102 can include a model, make, and/or serial number of the equipment, such as a motorized recreational vehicle 1104, information about the owner and/or operator of the equipment, a registered address of the equipment, a color of the equipment, features of the equipment, or the like.

The application executed on the mobile computing device 1106 can be configured to request capture of an image of the barcode 1102 on the equipment, such as the unmanned vehicle 1104. The application can be configured to access the camera functionality of a mobile computing device 1106. The capture area 1108 for the barcode 1102 can be a size configured to ensure capturing a sufficiently large amount of the equipment to verify the identity of the equipment. The capture area 1108 can have a size configured to ensure capture of a sufficient amount of background. The background can include elements of the environment in which the equipment is being operated. Image analysis can be employed to determine whether or not the captured image is a genuine image of the equipment, such as a motorized recreational vehicle, in the environment it will be operated in, and not just a photograph of the equipment, or the like. The image analysis can be performed by the mobile computing device or it can be performed by a server, wherein the mobile computing device uploads the image to the server.

The application can be configured to facilitate decoding of the barcode 1102. The decoded information can be saved by the mobile computing device 1106 to verify that the mobile computing device and the equipment are in the same location. The decoded information can also be stored for use in the event of a claim. The decoded information and/or the captured photograph can be transmitted to a server, such as server 106. The decoded information can be verified by the server 106.

The application executed on the mobile computing device 1106 can be configured to access geolocation information associated with the mobile computing device. The application can be configured to embed the geolocation information, of the mobile computing device, into the captured image. For example, the application can be configured to add or modify metadata associated with the captured image with geolocation information of the mobile computing device. The application can be configured to modify one or more pixels of the captured image.

The modification of the one or more pixels providing an indication of the location of the mobile computing device 1106 at the time the image is captured.

The captured image can include a timestamp. The timestamp can be incorporated into the metadata and/or the pixels for the captured image.

In some variations, the equipment, such as a motorized recreational vehicle, may include one or more sensors for facilitating a determination of the location of the motorized recreational vehicle. FIG. 12 is an illustration of a system having one or more elements consistent with the present description. Equipment, such as a motorized recreational vehicle 1202 can include one or more sensors. The sensor(s) can be incorporated into the hull 1204 of the motorized recreational vehicle 1202. In some variations, the sensor(s) can be part of the payload 1206 of the motorized recreational vehicle 1202.

One or more components of the equipment can be configured to communicate with a user's mobile computing device. Communication can be performed over a relatively short-range communication protocol facilitating determination that the equipment is within the vicinity of the mobile computing device.

In some variations, geolocation information of the equipment can be transmitted by the equipment to provide information as to the geographic location of the equipment. For example, the one or more components can include a geolocation signal receiver. The geolocation signal receiver can be configured to receive signals from one or more satellite-based geolocation systems, that use satellites 1208 to transmit signals, for example, GPS, Galileo, Beidou, or the like. In some variations, the geolocation signal receiver can be configured to receive signals from one or more ground-based geolocation systems. The geolocation signal receiver can be configured to receive one or more signals from a base station 1210 on the ground. Such base stations 1210 can be included on a boat.

In some variations, the equipment, such as a motorized recreational vehicle 1202, can include geolocation circuitry. The geolocation circuitry can be configured to determine the geolocation of the equipment in response receiving geolocation signals. In some variations, the equipment can be configured to transmit the geolocation signals received at the equipment to one or more remote computing systems. A remote computing system(s) can include a mobile device 1212, a server (such as server 106 in FIG. 1), a base station 1210, or the like. The remote computing system can be configured to determine the geolocation of the equipment, such as the motorized recreational vehicle 1202, based on the geolocation signals.

In some variations, the equipment, such as a motorized recreational vehicle 1202, can comprise electronic data storage. The equipment can be configured to save at least an indication of the geolocation signals received at the equipment for later processing. For example, the equipment may not have wireless data transmission capabilities, or may be out of range of a designated receiver. In such cases, the equipment can save the geolocation signals received at the equipment in electronic data storage. When the equipment comes into range of a wireless communication system, or is connected to a computing system that can receive the geolocation signals, the equipment can be configured to transmit the geolocation information associated with the equipment.

In some variations, the equipment can be configured to continuously or intermittently transmit geolocation information. The equipment can be configured to relay geolocation signals and/or timestamps or the determined geolocation of the equipment, to a remote computing device, such as a controller or mobile computing device 1212. A retransmitter may be employed to relay information between a mobile computing device 1212 and the equipment. The retransmitter can be incorporated into a controller of the equipment.

The following description describes various methods and systems in relation to motorized recreational vehicles. However, the described methods and systems relate equally to equipment in general used by users to participate in insurable activities. The remote computing device can be configured to notify the user in the event that the equipment, such as a motorized recreational vehicle 1202, ventures into a no-use zone, a different insurance zone, a dangerous area, or the like. For example, the motorized recreational vehicle 1202 could venture into a no-use zone, such as area 604 illustrated in FIG. 6. The user can receive a notification that the motorized recreational vehicle 1202 has ventured into the no-use zone and the user can change the course of the motorized recreational vehicle. As described with respect to FIG. 5, different areas or zones can have different levels of risk and therefore operating a motorized recreational vehicle in those zones can have different premiums. In the event that a motorized recreational vehicle ventures into a different insurance zone, such as from zone 504 into zone 506, as illustrated in FIG. 5, the remote computer can be configured to notify the user of that fact.

The motorized recreational vehicle and/or remote computer can be configured to determine a future location of the motorized recreational vehicle based on the behavior of the motorized recreational vehicle. The motorized recreational vehicle and/or remote computer can be configured to generate a notification in response to determining that the unmanned vehicle is headed for a no-fly zone or a different insurance zone. When the notification indicates that the motorized recreational vehicle is headed toward a different insurance zone, such as from insurance zone 504 to insurance zone 506, the notification can include an option to accept entry into the different insurance zone. A user can interact with the remote computer and accept the different insurance terms.

The motorized recreational vehicle 1202, or a remote computer in communication with the motorized recreational vehicle 1202 can be configured to continuously or intermittently monitor the geolocation of the motorized recreational vehicle 1202. A user, manufacturer, or the like, can configure the motorized recreational vehicle 1202 to avoid venturing into no-use zones, or different insurance zones, or the like. In some variations, a user may select a maximum premium that they are willing to pay, and the motorized recreational vehicle 1202 can be configured to avoid zones that exceed that maximum premium.

In the example where the notification provides an option to accept the different insurance terms of a different insurance zone, the motorized recreational vehicle 1202 can be configured to continue into the different insurance zone in response to the user accepting the different insurance zones, and stop at the border between insurance zones, in the event that the user does not. In some variations, where the motorized recreational vehicle is venturing toward a no-use zone, the notification can include an override option, which, when interacted with, can override any geolocation limiting elements, and allow the motorized recreational vehicle to continue into the no-use zone. In the event that the motorized recreational vehicle enters a no-use zone or any other zone that is not covered by the user's insurance policy, a notification can be presented to the user to indicate that the user currently has no insurance coverage.

The motorized recreational vehicle 1202 can be controlled by a controller 1214. The controller 1214 can be in electronic communication with the motorized recreational vehicle 1202. The controller 1214 can be in electronic communication with one or more of the mobile computing device 1212 or a base station 1210. The electronic communication between the controller 1214 and the mobile computing device 1212 or base station 1210 can be of a type having a known range. The range can be limited to a distance that indicates that the controller 1214 is within close proximity to the mobile computing device 1212 or the base station 1210. This can facilitate ensuring that the motorized recreational vehicle 1202 is within a certain distance of the mobile computing device 1214 or base station 1210 so that the location of the motorized recreational vehicle 1202 can be verified during operation of the motorized recreational vehicle 1202.

The motorized recreational vehicle 1202 can include one or more motion sensors. The one or more motion sensors can include an accelerometer, a gyroscope, a compass, a barometer, or the like. The motorized recreational vehicle 1202 can include circuitry configured to determine a location of the unmanned vehicle within three-dimensional space based on outputs from the one or more motion sensors. The location information can be stored on the motorized recreational vehicle and/or transmitted to the controller 1214 and/or a mobile computing device 1212. In some variations, the location information can be transmitted to the mobile computing device 1212 through the controller 1214.

The one or more motion sensors can be disposed within the hull 1204 of the motorized recreational vehicle 1202. In some variations, the one or more motion sensors can be included in a sensor attachment for attaching to the hull 1204 of the motorized recreational vehicle 1202. The sensor attachment can be disposed on the hull of the motorized recreational vehicle or can be disposed internal to the motorized recreational vehicle. In the event of the motorized recreational vehicle 1202 being involved in a loss-causing event, the sensor attachment can be detached from the motorized recreational vehicle 1202 and sent to the insurer for analysis. In some variations, the sensor attachment can be tamperproof and configured to only be accessed and read by the insurance provider or an associate of the insurance provider. The sensor attachment can be physically tamperproof and/or electronically tamperproof.

Measurements taken from the one or more motion sensors can be used to determine the location of the motorized recreational vehicle. For example, when a start point is known relative to a fixed point, the measurements taken by the motion sensor(s) as the motorized recreational vehicle is operated can facilitate determination of the location of the motorized recreational vehicle from that initial start point. The motion sensors can include directional motion sensors, altitude sensors, or the like. In some variations, the motion sensors may be configured to detect a velocity and/or change in velocity of the motorized recreational vehicle in any given direction. This detected information can be used to track the motion of the motorized recreational vehicle from the known start point.

Information generated by the motion sensor(s) can be used to determine how the operator is operating the motorized recreational vehicle. If the motorized recreational vehicle is being operated in an erratic or dangerous manner, indicating high-risk behaviors of the operator, this can provide an indication for the insurance provider that the operator is a high-risk operator. Insurance premiums can be tailored or adapted based on the manner in which the operator operates the motorized recreational vehicle.

In some variations, the data generated by the sensor(s) can be stored in a “black box” stored on or in the motorized recreational vehicle 1202. The black box can be configured to withstand the stresses and conditions experienced due to crashes experienced by the motorized recreational vehicle. The data stored on the “black box” can include information associated with the operation of the motorized recreational vehicle immediately prior to, and during, an accident event. This information can be used by an insurance provider in the event of a claim to determine whether the motorized recreational vehicle was being operated in compliance with the terms of the operator's insurance policy.

In some variations, communication can be facilitated between an insurance server, such as server 106, and the motorized recreational vehicle and/or controller of the motorized recreational vehicle, through one or more wireless wide-area networks. For example, a wireless wide-area network can include sub-GHz technology. Base stations can be disposed in location across a geographic region. The motorized recreational vehicle and/or controller can include sub-GHz transceivers for transmitting and receiving information to and from sub-GHz base stations.

The one or more sensors disposed on the motorized recreational vehicle can be configured to detect an accident experienced by the motorized recreational vehicle. For example, a sensor can be configured to detect an impact and/or a sudden change in direction and/or velocity experienced by the motorized recreational vehicle. In some variations, multiple sensors may be used to detect a relative difference in motion between the two sensors. For example, if the motion of a first sensor indicates that it has changed location relative to the location of a second sensor it may indicate that there has been an accident where motorized recreational vehicle has become damaged. Difference in relative location of different sensors can be determined based on inter-sensor communications. Signal strength may change based on the location of the sensors. In some variations, the motion detected by the two sensors may deviate which can be used to determine the difference in the location of both sensors.

In response to detecting an accident, the measurements taken by the one or more sensors over a predefined period of time leading up to the accident, can be saved on electronic storage. The measurements can be stored on electronic storage in the motorized recreational vehicle.

Measurements covering a set period of time can be stored on the electronic storage. If no accident occurs, the measurements can be overwritten with new measurements. The measurements can be transmitted to a remote computing device, such as a mobile computing device, and saved in electronic storage of the remote computing device.

The measurements taken by the one or more sensors of the motorized recreational vehicle can be configured to verify that the one or more sensors are actually on the motorized recreational vehicle during the period that the motorized recreational vehicle was allegedly in use. Motion profiles associated with the motorized recreational vehicles can be determined from measurements taken by sensors attached to, or incorporated into, different types of motorized recreational vehicles. When the motion revealed by the measurements of the one or more sensors does not follow usual patterns or trends it may indicate that the sensor(s) are not on the motorized recreational vehicle.

The measurements by the sensors can be used overtime to determine whether the user is a dangerous user of the motorized recreational vehicle or a safe user of the motorized recreational vehicle. Insurance premiums for users can be modified based on determining whether or not the user is a safe or unsafe operator of motorized recreational vehicles.

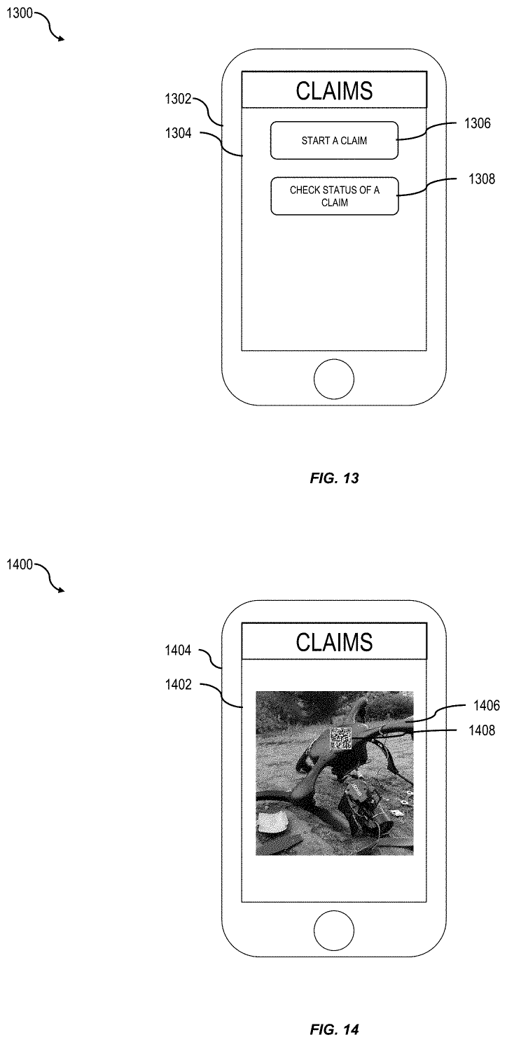

FIG. 13 is an illustration of a graphical user interface having one or more elements consistent with the present description. A user can make a claim in the event of an accident. An application executed on a user device 1302 can be configured to facilitate presentation of a graphical user interface 1304 on a display of the user device 1302. The graphical user interface 1304 can be configured to facilitate the making of a claim by a user. The graphical user interface 1304 can include a start claim button 1306. In response to the user interacting with the start claim button 1306, the application can be configured to facilitate entry and/or selection of information related to the user's claim.

The graphical user interface 1304 can include a check claim status button 1308. The status of a user's claim can be presented to the user on a display of the user device 1302 in response to the user interacting with the check claim status radio button 1308.

The application can be configured to request that the user capture an image of the damage, location, or the like, associated with the claim. FIG. 14 is an illustration of a graphical user interface 1402 having one or more elements consistent with the present description. The graphical user interface can be presented on a display of a user device 1404. The graphical user interface 1402 can be configured to facilitate the taking of an image(s) of the damage, location, or the like, associated with the claim. For example, the graphical user interface 1402 can facilitate the taking of an image(s), or video, of damage sustained by the motorized recreational vehicle 1406 associated with the claim. The image(s) or video can be obtained using a camera of the user device 1404.

Verification that the equipment, such as a motorized recreational vehicle 1406, associated with the claim is the same equipment that is insured under the insurance policy can be provided by at least ensuring that the barcode 1408 is within the field-of-view of the camera. In some variations, image recognition can be implemented to determine whether the equipment in the captured image is the same equipment that is insured by the insurance policy. Correlation of the images taken prior to a loss-causing event and images taken at or after the loss-causing event, of the equipment, can be correlated. The image(s) or video captured by the user device 1404 can be transmitted to a server, such as server 106, for facilitating the processing of a claim. Image processing software can be implemented to verify that the image taken by the user device 1404 is a genuine image and that the barcode 1408 is genuinely on the motorized recreational vehicle 1406.

A comparison between the barcode 1408 captured as part of the claim process and the barcode 1102 captured as part of the registration and insurance purchase process can be made. Image processing software and/or administrators can verify that the same motorized recreational vehicle 1406 appears in both images.

In some variations, telemetry data of an unmanned recreational vehicle recorded during a predetermined period prior to a claim event, an event that results in a claim, can be uploaded from the unmanned recreational vehicle to the insurance provider servers. For example, telemetry data can be transmitted from an unmanned recreational vehicle 102 to the server 106. In some variations, the telemetry data can be transmitted via a mobile computing device 104.

In some variations, in response to a user starting a claim, instructions can be transmitted to the mobile user device associated with the user, for example, mobile user device 1302.

Actuarial tables associated with the insurance provider can be updated based on insurance policy purchase information and claim information.

In some variations, users who need to obtain an insurance policy for using a motorized recreational vehicle may not be capable of entering into contracts. Such users may be minors, mentally impaired, or the like. To facilitate those users being insured, a companion application can be provided for use by an individual who is willing to enter into the contract on behalf of the user. The features of the companion application can be a feature of the same application as downloaded by the user.

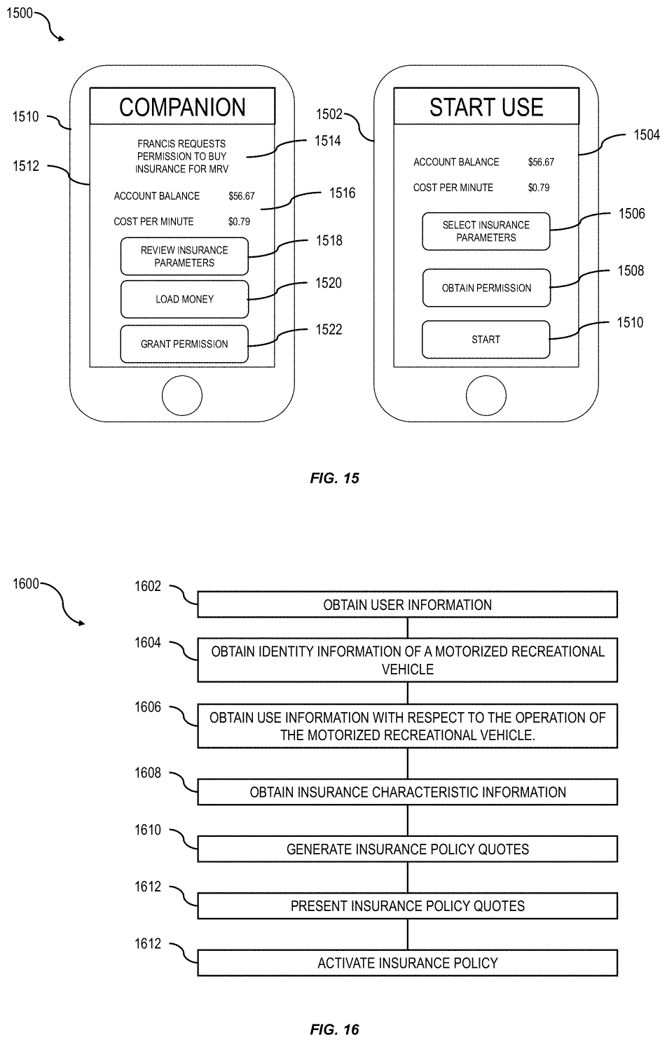

FIG. 15 is an illustration of a system for facilitating obtaining of an insurance policy for a motorized recreational vehicle by a user who is not able and/or willing to contract with an insurance provider, having one or more features consistent with the present description. Such as user may be, for example, a minor child. An application can be configured to be executed on a user device 1502 of a user. The application can be can be configured to facilitate presentation of a graphical user interface 1504 on a display of the user device 1502. The graphical user interface 1504 can be configured to facilitate selection and/or entry of information to obtain an insurance policy. The information obtained can be similar to the information obtained with respect to the graphical user interface 702 illustrated in FIG. 7.

After the user has selected insurance parameters through interaction with insurance parameter button 1506, the user can select permission button 1508. In response to the user requesting permission to obtain the insurance premium, a notification can be presented on a display of another user device 1510 associated with the contracting party. The requested insurance policy information can be transmitted to the other user device 1510 from the user device 1502 through a server, such as server 106. In some variations, the insurance policy information can be transmitted to the server 106 from the user device 1502. The server 106 can then transmit information associated with the insurance policy to the user device 1510 of the contracting party.

The contracting party can be an individual or organization willing to enter into a contract for an insurance policy on behalf of the user. For example, the contracting party may be a parent of a minor child who is otherwise unable to enter into a contract for an insurance policy. The notification can include an indication that the user has requested permission to obtain an insurance policy for using a motorized recreational vehicle. The contracting party may interact with the notification causing a graphical user interface 1512 to be presented on a display of the user device 1510.

The graphical user interface 1512 can include a notification 1514 that the user desires to obtain an insurance policy for using a motorized recreational vehicle. Account information 1516 can be presented to the contracting party through the graphical user interface 1512. The graphical user interface 1512 can be configured to facilitate review of the insurance parameters 1518 selected by the user. The contracting party may amend the insurance parameters 1518.

The graphical user interface 1512 may be configured to facilitate loading of money 1520 into an account associated with the insurance policy.

When the contracting party is satisfied with the insurance policy selected by the user and/or modified by the contracting party, the contracting party may grant permission to the user to obtain the insurance policy. The contracting party may grant permission by selecting grant permission button 1522. Granting permission may include the contracting party purchasing the insurance policy on behalf of the user. The insured party may be the contracting party, with the user being a secondary user of the motorized recreational vehicle with respect to insurance coverage. In some variations, the contracting party may put a time limit for the coverage period giving the user a particular length of time to use the motorized recreational vehicle.

In response to the contracting party accepting the insurance policy terms, and purchasing the insurance policy on behalf of the user, the graphical user interface 1504 on the user device 1502 associated with the user can be configured to provide an indication that the insurance policy has been approved and purchased. The graphical user interface 1504 can be configured to facilitate start of the coverage period for the insurance policy. In some variation, the user may select start button 1510 to start the coverage period.

It is anticipated that insurance will become a legal requirement for using motorized recreational vehicles on public or semi-public property. When a motorized recreational vehicle is being used with an insurance policy, a database can be populated that includes identity information of the motorized recreational vehicle, identity information of the user, insurance policy information, or the like. This database may be accessible by law enforcement or other government officials to verify that a motorized recreational vehicle being used in a particular location is currently insured. This can avoid unnecessary interactions with law enforcement for users of motorized recreational vehicles.

When a government official, such as law enforcement, comes across a motorized recreational vehicle being used at a particular location, law enforcement can request, from the database, information associated with insured motorized recreational vehicles that are currently being used in that area. The information provided by the database can provide one or more identifying pieces of information to facilitate determination by government officials that the motorized recreational vehicle is insured. Where the information received does not match with the motorized recreational vehicle being used, or there is no information about an insured motorized recreational vehicle in that area, the government official may then make further investigations.

One or more features can be facilitated by one or more processors, such as processor(s) 126, illustrated in FIG. 1. Processor(s) 126 can be configured to provide information processing capabilities to a computing device having one or more features consistent with the current subject matter. The computing device can be, for example, a server, such as server 106, user device 104, user device 105, or the like. Processor(s) 126 may include one or more of a digital processor, an analog processor, a digital circuit designed to process information, an analog circuit designed to process information, a state machine, and/or other mechanisms for electronically processing information. Although processor 126 is shown in FIG. 1 as a single entity in server 106, this is for illustrative purposes only. In some variations, processor 126 may include a plurality of processing units. In some variations, processor 126 may be located in any of the aforementioned computer systems. These processing units may be physically located within the same device, or processor 126 may represent processing functionality of a plurality of devices operating in coordination. The processor 126 may be configured to execute machine-readable instructions, which, when executed by the processor 126 may cause the processor 126 to perform one or more of the functions described in the present description. The functions described herein may be executed by software; hardware; firmware; some combination of software, hardware, and/or firmware; and/or other mechanisms for configuring processing capabilities on processor 126.

Electronic storage 108 may comprise electronic storage media that electronically stores information. The electronic storage media of electronic storage 108 may include one or both of system storage that is provided integrally (i.e., substantially non-removable) with a computing device, such as server 106, and/or removable storage that is removably connectable to server 106 via, for example, a port (e.g., a USB port, a firewire port, etc.) or a drive (e.g., a disk drive, etc.). Electronic storage 108 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage xx may include one or more virtual storage resources (e.g., cloud storage, a virtual private network, and/or other virtual storage resources). Electronic storage 108 may store software algorithms, information determined by processor 126, information received from one or more computing devices, such as server 106, client computing devices 104, 105, or the like, information that enables the one or more computing device to function, or the like.

FIG. 16 illustrates a method 1600 having one or more features consistent with the current subject matter. The operations of method 1600 presented below are intended to be illustrative. In some embodiments, method 1600 may be accomplished with one or more additional operations not described, and/or without one or more of the operations discussed. Additionally, the order in which the operations of method 1600 are illustrated in FIG. 16 and described below is not intended to be limiting.

In some embodiments, method 1600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1600 in response to instructions stored electronically on an electronic storage medium. The one or more processing devices may include one or more devices configured through hardware, firmware, and/or software to be specifically designed for execution of one or more of the operations of method 1600.

At 1602, user information can be obtained. User information can include an identity of the user, an age of the user, experience of the user, prior claim information of the user, or the like.

At 1604, the identity of a motorized recreational vehicle may be obtained.

At 1606, use information can be obtained with respect to the operation of the motorized recreational vehicle. Use information can include a location in which the motorized recreational vehicle will be used, a time at which the motorized recreational vehicle will be used, or the like.

At 1608, insurance characteristic information can be obtained. Insurance characteristic information can include liability coverage level, deductible, hull coverage, medical coverage, or the like.

At 1610, insurance policy quotes can be determined based on the information provided at 1602, 1604, 1606 and 1608.

At 1612, insurance policy quotes can be presented to the user.

At 1614, an insurance policy can be activated in response to acceptance by the user of the insurance policy.

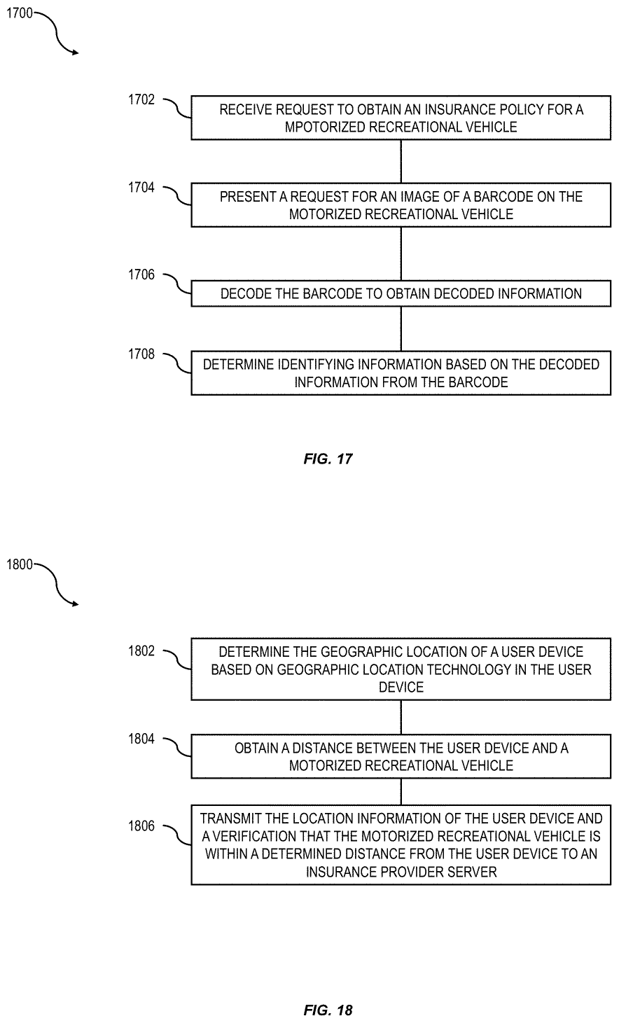

FIG. 17 illustrates a method 1700 having one or more features consistent with the current subject matter. The operations of method 1700 presented below are intended to be illustrative. In some embodiments, method 1700 may be accomplished with one or more additional operations not described, and/or without one or more of the operations discussed. Additionally, the order in which the operations of method 1700 are illustrated in FIG. 17 and described below is not intended to be limiting.

In some embodiments, method 1700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1700 in response to instructions stored electronically on an electronic storage medium. The one or more processing devices may include one or more devices configured through hardware, firmware, and/or software to be specifically designed for execution of one or more of the operations of method 1700.

At 1702, a request to obtain an insurance policy for use of a motorized recreational vehicle can be received by an insurance policy provider through a user device associated with a user.

At 1704, a request to obtain an image of a barcode on a motorized recreational vehicle can be presented on the user device associated with the user.

At 1706, the image of the barcode, obtained with the user device, can be analyzed to decode the barcode.

At 1708, identifying information can be determined based on the decoded information from the barcode. The identifying information can include information about the user, the motorized recreational vehicle, or the like.

FIG. 18 illustrates a method 1800 having one or more features consistent with the current subject matter. The operations of method 1800 presented below are intended to be illustrative. In some embodiments, method 1800 may be accomplished with one or more additional operations not described, and/or without one or more of the operations discussed. Additionally, the order in which the operations of method 1800 are illustrated in FIG. 18 and described below is not intended to be limiting.

In some embodiments, method 1800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1800 in response to instructions stored electronically on an electronic storage medium. The one or more processing devices may include one or more devices configured through hardware, firmware, and/or software to be specifically designed for execution of one or more of the operations of method 1800.

At 1802, the geographic location of a user device can be determined based on geographic location technology on the user device.

At 1804, a distance of the motorized recreational vehicle from the user device can be obtained based on one or more signals transmitted between one or more components on the motorized recreational vehicle and the user device.

At 1806, the location of the user device and verification that the motorized recreational vehicle is within a determined distance from the user device can be transmitted to an insurance server.

Referring to FIG. 1, use information by users of their unmanned recreational vehicles can be obtained by user devices 104. This use information can be sent to a database managed by the server 106. In some exemplary variations, the database can be stored in electronic storage 108. Use information can include, for example, when the users used their motorized recreational vehicles, how long the users used their motorized recreational vehicles, where the users used their motorized recreational vehicles, which motorized recreational vehicles users use, which motorized recreational vehicles users own, or the like. In some variations, user use information can accompany demographic information.

In some variations, user use information can be genericized to avoid revelation of personally identifiable user information associated with the users. In some variations, the user use information can be genericized by assigning users to categories comprising ranges of values for user use parameters and/or user demographic parameters. For example, a category could include use by the user of a motorized recreational vehicle within a geographic region comprising a particular area, for example, a city block, a square mile, or the like. Another example of a category can include a user age-range, gender, education level, income level, or the like.

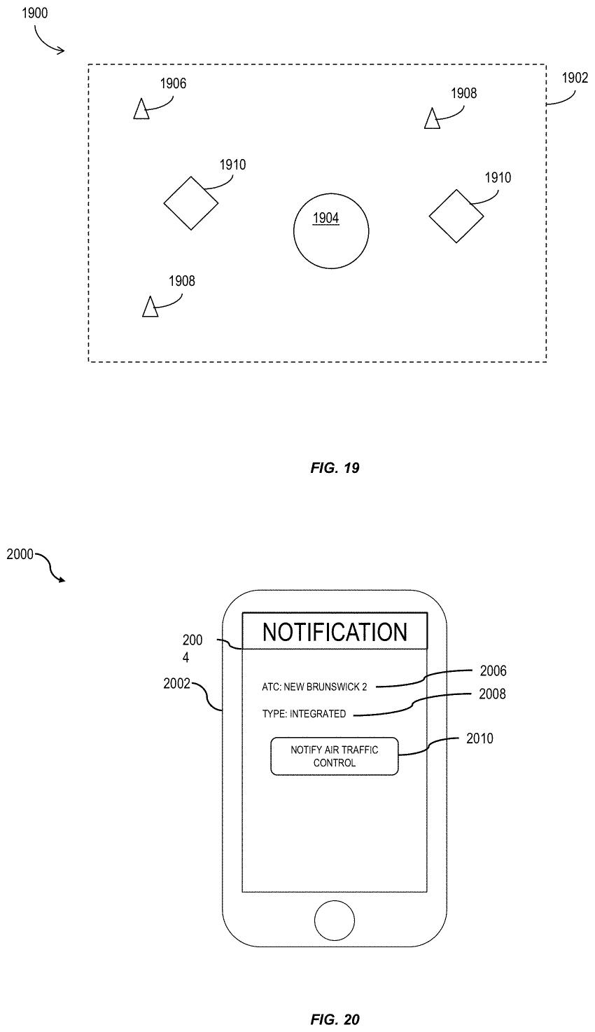

FIG. 19 is an illustration of a system 1900 having one or more features consistent with the present description. FIG. 19 illustrates airspace 1902 controlled by an air-traffic control system 1904. The air-traffic control system 1904 can include an automated air-traffic control system, an air-traffic control tower, or the like. In some jurisdictions it may be a legal requirement for a user of an airborne motorized recreational vehicle, such as an unmanned aerial vehicle, or the like, to notify the air-traffic control system 1904 of the user's intention to operate an airborne motorized recreational vehicle in airspace 1902 controlled by the air-traffic control system 1904.

FIG. 20 illustrates a system 2000 having one or more features consistent with the present description. When a user of an unmanned aerial vehicle 1906 starts using the unmanned aerial vehicle 1906 in a particular airspace 1902, the user may be required to notify the air-traffic control system 1904 that controls the air traffic that operates within that airspace 1902. In some variations, when a user starts an insurance policy, for example, as described with respect to FIG. 10, a user device 2002 associated with the user, on which the user started the insurance policy, may notify the air-traffic control system 1904.

The user device 2002 may include a graphical user interface 2004. The graphical user interface 2004 may include an indication of the air-traffic control system 2006 covering the airspace in which the user intends to fly the unmanned aerial vehicle. The air traffic control system 2006 may having one or more categories. The graphical user interface 2004 can include an indication 2008 of the category associated with the air traffic control system 2006. The category may include an indication of the communication systems over which the air traffic control system can receive notifications from users of unmanned aerial vehicles. The communication systems may include, telephone, email, SMS, MMS, telephone call, or the like.

In some variations, the air-traffic control system may be integrated with one or more applications implemented on the user device 2002, a controller associated with an unmanned aerial vehicle, the unmanned aerial vehicle, or the like. Consequently, when a user starts a session, the user device 2002 can be configured to automatically send a notification to the air-traffic control system 2006 that the use is operating an unmanned aerial vehicle in the airspace 1902 controlled by the air-traffic control system.

In some variations, there the air-traffic control system is not integrated, the user device 2002 may be configured to use one or more other communication systems to notify the air-traffic control system. For example, the user device 2002 may facilitate sending of an email, an automated telephone call, an SMS, an MMS, or the like, to the air-traffic control system. In some variations, where the air-traffic control system would require a personal telephone call from the user of the unmanned aerial vehicle, the user device 2002 can be configured to facilitate connection, of the user, with the air-traffic control system through a telephone call.

Referring to FIG. 19, the unmanned aerial vehicle 1906 can be configured to react to a notification and/or instruction from the air-traffic control system 1904 that is controlling and/or monitoring the airspace 1902. For example, a condition may occur within the airspace 1902 that requires the unmanned aerial vehicle 1906 to return to the ground. The air-traffic control system 1904 can be configured to issue a notification indicating that all unmanned aerial vehicles need to return to the ground. This notification can be broadcast from a transmitter associated with the air-traffic control system 1904, through the Internet, through a telephone call, or the like.

In some variations, one or more of the unmanned aerial vehicle, a controller for the unmanned aerial vehicle, a user device associated with the user of the unmanned aerial vehicle, or the like, can be configured to receive notifications from the air-traffic control system 1904. In some variations, any of these elements can be configured to receive notifications broadcast from a transmitter associated with the air-traffic control system 1904. In some variations, any of these elements can be configured to receive notifications over the Internet, for example, by email, through notifications using applications and/or other means of receiving notifications over the Internet.

In some variations, the user may comply with the notification by controlling a decent of the unmanned aerial vehicle and/or a return to the user of the unmanned aerial vehicle. In some variations, the unmanned aerial vehicle may be configured to automatically comply with a notification from the air-traffic control system 1904. The unmanned aerial vehicle may be configured to return to its point of origin when the air-traffic control system 1904 sends a notification to unmanned aerial vehicles 1906 to land. In some variations, the controller of the unmanned aerial vehicle 1906 may be configured to control a return of the unmanned aerial vehicle to its point of origin. In other variations, the unmanned aerial vehicle 1906 may be configured to control itself back to its point of origin. In such variations, the user may be able to override the self-control of the unmanned aerial vehicle, for example, to avoid collision, damage, or the like.

Notifications may be provided from the air-traffic control system 1904 for one of many different reasons. For example, an emergency situation may occur which requires the grounding of all aircraft in an area, or a removal of all aircraft from an area. Other situations may occur such as the landing of an aircraft with a sensitive status, such as an aircraft protected by the secret service, or the like.

In some variations, different aircraft within an airspace 1902 may have different priority levels. For example, one or more other unmanned aerial vehicles 1908 may be within the same airspace as unmanned aerial vehicle 1906. There may exist a priority level for each of the other unmanned aerial vehicles 1908 relative to the unmanned aerial vehicle 1906. When one or more unmanned aerial vehicles approach each other, one of the unmanned aerial vehicles may be required to give way to the other. Which drone gives way may be determined by a set of priority rules. The priority rules may include a direction of movement of the unmanned aerial vehicle, a direction of movement of the unmanned aerial vehicle with respect to the direction of the wind, a relative hierarchy of the unmanned aerial vehicles, a function being performed by the unmanned aerial vehicles, or the like.

In some variations, other aircraft 1910 may be operating in an airspace 1902. Other aircraft may include large manned aircraft. The aircraft 1910 may have priority over unmanned aerial vehicles, requiring unmanned aerial vehicles to give way to the aircraft 1910.

In some variations, communication of the location of the various unmanned aerial vehicles 1906 and 1908 and aircraft 1910 may be facilitated through the air-traffic control system 1904. In other variations, communication of the location of the various unmanned aerial vehicles 1906 and 1908 and aircraft 1910 may be facilitated through one or more beacons disposed on the unmanned aerial vehicles and/or aircraft.

Each unmanned aerial vehicle and/or aircraft may be provided with an individual beacon. A beacon may be configured to transmit a signal on a designated frequency. The designated frequency can be a frequency commonly used by aircraft to transmit their locations. The signal can facilitate identification of the aircraft or unmanned aerial vehicle associated with the beacon. In some variations, the signal may include an identifier of the beacon, which, in-turn, may be mapped to an identity of the aircraft or unmanned aerial vehicle. In other variations, the signal my include an identifier of the aircraft or unmanned aerial vehicle, a type of the aircraft or unmanned aerial vehicle, a capability of the aircraft or unmanned aerial vehicle, or the like.

The signal can include an indication of the location of the aircraft or unmanned aerial vehicle. In some variations, the signal may include a coordinate of the aircraft or unmanned aerial vehicle. The coordinate can be obtained from geographical location technology in communication with the beacon. In some variations, the signal may have an indication of the transmission strength at transmission of the signal from the beacon. A receiver on other aircraft can determine the strength of the signal at receipt and determine the distance they are from the aircraft based on the indication of the transmission strength included in the signal.

FIG. 21 illustrates geofencing for motorized recreational vehicles. A motorized recreational vehicle 2106 may be geofenced. Geofencing permits constraining the motorized recreational vehicle 2106 to a defined area. A geofence can represent the geographical limits of the area in which the motorized recreational vehicle 2106 can be used. For example, motorized recreational vehicle 2106 can be constrained by geofence 2102. The motorized recreational vehicle 2106 can be configured to not pass the limits of the geofence 2102. When the motorized recreational vehicle 2106 approaches the limit of the geofence 2102, the motorized recreational vehicle 2106 can be configured to slow and eventually stop.

Different motorized recreational vehicles can have different geofenced areas. For example, motorized recreational vehicle 2108 can be associated with a geofenced area 2104. Geofenced areas may overlap, for example, geofenced area 2102 and geofenced area 2104 may overlap.

Unmanned recreational vehicles may share a geofenced area. For example, motorized recreational vehicle 2110 may share geofenced area 2102 with motorized recreational vehicle 2106. In some variations, a geofenced area may be designated by a group of users of motorized recreational vehicles. Such a group may be a group of friends, acquaintances, members of a club, a training school, or the like. When a user is within a vicinity of a geofenced area belonging to a group, a notification may be provided, on a user device of the user and/or controller associated with the motorized recreational vehicle, that identifies the existence of the geofenced area and an invitation to join the geofenced area.

In some variations, air-traffic control systems, controlling airspace in which a geofenced area is located, may be able to modify the boundaries of the geofenced area. For example, instead of forcing all unmanned aerial vehicles to descend in response to an event, the boundaries of the geofenced areas may be modified to move the geofenced areas away from a location that the air-traffic control system desires to be free from unmanned aerial vehicles. In response to a change in the boundaries of a geofenced area, the unmanned aerial vehicle may be configured to move toward the user of the unmanned aerial vehicle within the geofenced areas.

With reference to FIG. 5, different insurers can offer insurance for using motorized recreational vehicles in different locations. For example, an insurance provider covering area 506 for a one type of motorized recreational vehicle may be different to the insurance provider covering area 504 for the same type of motorized recreational vehicle. Ordinarily, this may prevent a user of a motorized recreational vehicle of that type being insured in one of the areas if they move from area 504 into area 506. The presently described subject matter can facilitate insurance coverage provided by multiple insurance providers when the motorized recreational vehicle moves from an area covered by a first insurance provider into an area covered by a second insurance provider.

In some variations, a user device, such as a user device 104 illustrated in FIG. 1, can be configured to notify a server associated with a first insurance company upon detection that the motorized recreational vehicle has left an area covered by the first insurance company and a server associated with a second insurance company can be notified upon detection that the motorized recreational vehicle has entered an area covered by the second insurance company.

In some variations, area 504 and area 506 may overlap by an amount that facilitates handover from one insurance company to another, or denial thereof. For example, a motorized recreational vehicle may be moving from area 504 covered by a first insurance company into area 506 covered by a second insurance company. There can be an overlap between areas 504 and 506 to facilitate handover between the first insurance company and the second insurance company. For purposes of discussion, the area of the overlap can be designated a handover zone. When a motorized recreational vehicle enters a handover zone, the second insurance company can be notified that the motorized recreational vehicle is moving toward an area that is covered by the second insurance company. The information about the motorized recreational vehicle and its user can be provided to the second insurance company. The second insurance company can determine whether it will provide insurance coverage to the motorized recreational vehicle and its user.

In some variations, the second insurance company, or a server associated with the second insurance company, can determine a premium for the motorized recreational vehicle and its user based on the insurance coverage parameters entered by the user when they initiated the first insurance policy. The user can then be charged that premium upon a notification that the user has left the handover zone and entered area 506.

The user can pre-specify settings for their insurance policy. For example, the user can select to automatically purchase and accept a policy from the second insurance company when they enter area 506 from area 504. In some variations, the user can set a maximum premium rate at insurance will automatically be purchased. When a premium exceeds this maximum premium rate that insurance will automatically be purchased, the user may receive an alert on their user device informing them of this and requesting an indication whether the user will accept the insurance rate. The alert can include a vibration, a notification, or the like.

In some variations, the notification or alert can be provided on a wearable associated with the user. For example, when the motorized recreational vehicle is an electric skateboard, or the like, the user may receive a notification on a smartwatch worn by the user. The smartwatch may facilitate notification and/or acceptance of an insurance premium displayed on a screen of the smartwatch. The user may accept the insurance premium while the user is riding the electric skateboard through the handover zone.

In some variations, group insurance may be provided for a group or team. In such variations, a group or team may acquire an insurance policy that covers use of motorized recreational vehicles in one or more geographic locations for members of the group or team. For example, a model aircraft association may obtain an insurance policy for their association members at a model aircraft airfield. In other variations, an electric skateboard team may obtain an insurance policy for team members at an electric skateboard park. A drone racing team may obtain a policy to cover drone racing team members at a drone racing venue for a period of time.

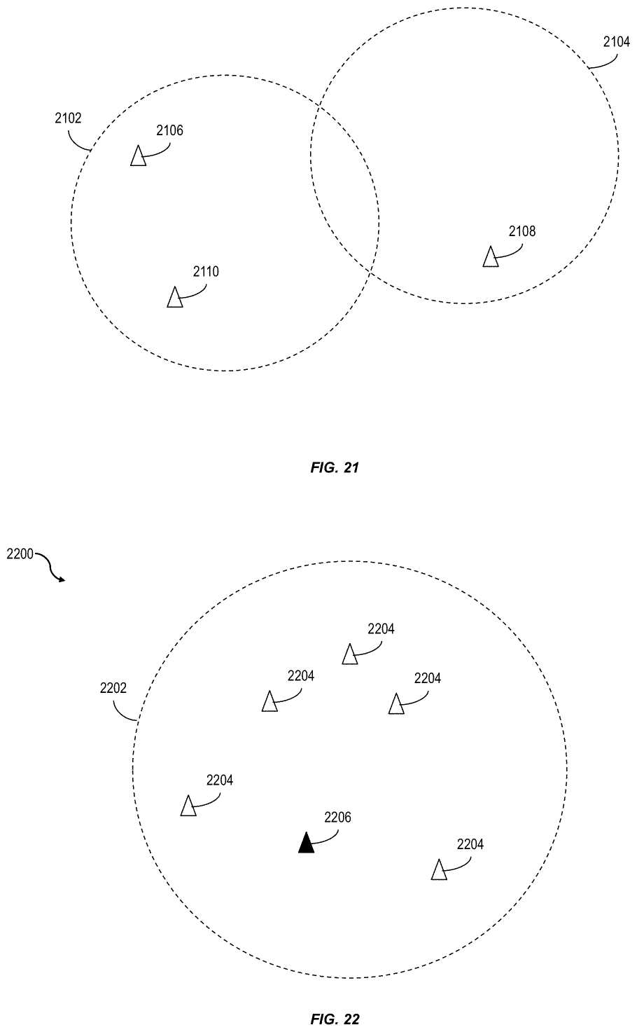

FIG. 22 illustrates a representation 2200 of a geographic region 2202. In some variations, non-users of motorized recreational vehicles may use a website, application, or the like, to monitor motorized recreational vehicles being used in a particular geographic region. Identity information and location information associated with a motorized recreational vehicle may be obtained by a centralized monitoring system. In some variations, the information may be obtained from platforms that provide insurance to users of motorized recreational vehicles, from mapping platforms that facilitate ensuring motorized recreational vehicles stay in legal areas, or the like.

With the location information an identity of the motorized recreational vehicle can be provided. The identity can include a registration number an identification number or the like. The location information and/or identity information of the motorized recreational vehicle can be used to identify whether a motorized recreational vehicle is being used legally or not.

For example, in the case of unmanned aerial vehicles, the identity and/or locations of the unmanned aerial vehicles 2204 being operated in a region 2202 can be used to identify that they are being operated legally within a region. Legally operating the vehicles 2204 can include one or more of verifying that the unmanned aerial vehicles 2204 comply with rules and regulations of the various jurisdictions that have rules and regulations covering the operation of unmanned aerial vehicles 2204 in a particular region 2202.

In some variations, it can be determined that unmanned aerial vehicle 2206 is not flying legally in a particular region. This information can be relayed to the authorities.

In some variations, altitude information can be provided together with geolocation information and identity information of the unmanned aerial vehicles. The geolocation information, altitude information and identity information can be used to virtually represent the unmanned aerial vehicles on a screen of a user device 2302.

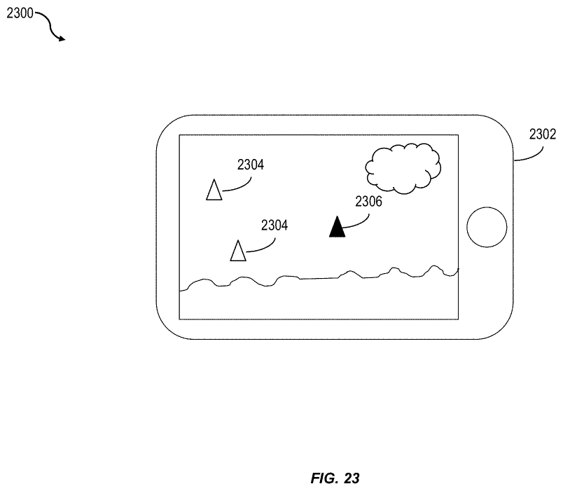

The user device 2302 can have a camera configured to feed images to a screen of the user device 2302. When the user of the user device 2302 holds up the user device 2302 displays the images in front of the user device 2302 on the screen of the user device 2302. For example, the user may point the camera of the user device 2302 toward one or more unmanned aerial vehicles. Location and/or orientation parameters of the user device 2302 can be used, together with the geolocation, altitude and/or identity parameters of unmanned aerial vehicles to present a virtual representation of the unmanned aerial vehicles on a screen of the user device 2302. In some variations, the virtual representation of the unmanned aerial vehicles can include an indication that the unmanned aerial vehicles are flying in accordance with all laws, rules, regulations, or the like, for example, as seen at 2304 in FIG. 23. In some variations, the virtual representation of the unmanned aerial vehicles can include an indication that the unmanned aerial vehicles are flying not in accordance with all laws, rules, regulations, or the like, for example, as seen at 2306 in FIG. 23.

As the user of the user device 2302 moves the user device 2302 to look at different views, the virtual representations of the unmanned aerial vehicles can move in a corresponding manner to facilitate the virtual representations appearing over the real unmanned aerial vehicles in the field-of-view of the camera of the user device 2302.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for providing an insurance policy covering use of an unmanned aerial vehicle, the method to be performed by at least one computer processor forming at least a part of a computing system and comprising:
obtaining, at the at least one computer processor, sensor data from a geolocation sensor, the sensor data including an indication of a location of a vehicle;
determining, from the sensor data and by the at least one computer processor, a location of the vehicle;
obtaining, at the at least one computer processor, one or more condition parameters, of one or more conditions, at the determined location of the vehicle;
determining, by the at least one computer processor, an insurance policy premium for an insurance policy covering use of the vehicle for a set period of time, the insurance policy premium based on the determined location of the vehicle and the one or more condition parameters;
transmitting, by the at least one computer processor, an indication of the insurance policy premium for display on a graphical user interface of a device associated with a user of the vehicle;
receiving, at the at least one computer processor and from the device associated with the user of the vehicle, confirmation data indicating an acceptance of the insurance policy premium, the acceptance received from the user through the graphical user interface;
logging, by the at least one computer processor, a time of acceptance of the insurance policy premium by the user; and
notifying, through the graphical user interface of the device associated with the user and upon expiration of the set period of time, that the insurance policy for use of the vehicle has expired.

2. The method of claim 1, further comprising:
receiving, at the at least one computer processor, additional sensor data from the geolocation sensor, an indication of the location of the vehicle during the set period of time.

3. The method of claim 2, wherein the additional sensor data is received at least periodically during the set period of time.

4. The method of claim 2, wherein the additional sensor data is received at the expiration of the set period of time.

5. The method of claim 1, wherein the geolocation sensor is disposed on the device associated with the user.

6. The method of claim 1, wherein the geolocation sensor is disposed on the aerial vehicle.

7. The method of claim 1, wherein the device is one or more of a mobile device and a controller of the aerial vehicle.

8. The method of claim 1, wherein the one or more conditions includes a proximity of the location of the unmanned vehicle to one or more of an airport, a school, and a restricted area.

9. The method of claim 1, wherein the one or more conditions includes a population density at the location of the unmanned vehicle.

10. The method of claim 1, wherein the vehicle is an unmanned aerial vehicle

11. A system comprising:
at least one computer processor; and,
a memory storing machine-readable instructions, which when executed by the at least one computer processor, cause the processor to perform one or more operations, the one or more operations comprising:
obtaining, at the at least one computer processor, sensor data from a geolocation sensor, the sensor data including an indication of a location of a vehicle;
determining, from the sensor data and by the at least one computer processor, a location of the vehicle;
obtaining, at the at least one computer processor, one or more condition parameters, of one or more conditions, at the determined location of the vehicle;
determining, by the at least one computer processor, an insurance policy premium for an insurance policy covering use of the vehicle for a set period of time, the insurance policy premium based on the determined location of the vehicle and the one or more condition parameters;
transmitting, by the at least one computer processor, an indication of the insurance policy premium for display on a graphical user interface of a device associated with a user of the vehicle;
receiving, at the at least one computer processor and from the device associated with the user of the vehicle, confirmation data indicating an acceptance of the insurance policy premium, the acceptance received from the user through the graphical user interface;
logging, by the at least one computer processor, a time of acceptance of the insurance policy premium by the user; and
notifying, through the graphical user interface of the device associated with the user and upon expiration of the set period of time, that the insurance policy for use of the vehicle has expired.

12. The system of claim 11, wherein the one or more operations further comprise:
receiving, at the at least one computer processor, additional sensor data from the geolocation sensor, an indication of the location of the vehicle during the set period of time.

13. The system of claim 12, wherein the additional sensor data is received at least periodically during the set period of time.

14. The system of claim 12, wherein the additional sensor data is received at the expiration of the set period of time.

15. The system of claim 11, wherein the geolocation sensor is disposed on the device associated with the user.

16. The system of claim 11, wherein the geolocation sensor is disposed on the vehicle.

17. The system of claim 11, wherein the device is one or more of a mobile device and a controller of the vehicle.

18. The system of claim 11, wherein the one or more conditions includes a proximity of the location of the vehicle to one or more of an airport, a school, and a restricted area.

19. The system of claim 11, wherein the one or more conditions includes a population density at the location of the vehicle.

20. The system of claim 1, wherein the vehicle is an unmanned aerial vehicle.
